(19) United States
(12) Patent Application Publication
(10) Pub. No.: US 2021/0285777 A1
(43) Pub. Date: Sep. 16, 2021

(54) METHOD, APPARATUS, AND SYSTEM FOR IDENTIFYING TRANSPORTATION TRANSITION REGIONS FROM PROBE DATA

(71) Applicant: HERE Global B.V., Eindhoven (NL)

(72) Inventors: Arash OSTADZADEH, Nuenen (NL); Tessa BERRY, Geneva, IL (US); Matei STROILA, Chicago, IL (US); Aniket MITRA, Den Haag (NL)

(21) Appl. No.: 16/815,927

(22) Filed: Mar. 11, 2020

(51) Int. Cl. G01C 21/34; G01C 21/36

(52) U.S. Cl. CPC G01C 21/3438; G01C 21/3476; G06F 16/29; G01C 21/3617; G01C 21/3682; G01C 21/3461

(57) ABSTRACT

An approach is provided for automatically identifying transportation transition regions (e.g., off-road pickup/drop-off locations) based on probe trajectory data. The approach involves, for example, determining a geographic area that encompasses a point of interest and an associated off-road region. The approach also involves retrieving probe trajectories that intersect the geographic area. The approach further involves segmenting the one or more probe trajectories into a plurality of segments that include on-road and/or off-road segments. The approach also involves processing the plurality of segments to identify one or more transition segments that include a transition involving an on-road segment of the one or more on-road segments or an off-road segment of the one or more off-road segments. The approach further involves clustering one or more probe points of the one or more transition segments to identify the transportation transition region. The approach further involves providing the transportation transition region as an output.

### BACKGROUND

Transportation services (e.g., ride-hailing services, vehicle-sharing services, etc.) often rely on knowing where users are likely to transition between different transportation services or modes of transport (e.g., referred to as transportation transition regions). For example, ride-hailing companies are particularly interested in identifying locations (e.g., transportation transition regions) where they need to navigate to efficiently pickup and/or drop-off passengers (e.g., to minimize operating costs). As the popularity of these transportation services increases, the number of possible pick-up/drop-off locations or other transportation transition regions (e.g., locations where vehicles can be picked-up or dropped-off for vehicle sharing services) also increases, thereby making it very resource-intensive to map such transportation transition regions. Accordingly, service providers face significant technical challenges to identify and map these regions or locations, particularly when such regions are located off-road where accurate mapping data may be unavailable or out-of-date.

### SOME EXAMPLE EMBODIMENTS

Therefore, there is a need for an approach for automatically identifying transportation transition regions (e.g., regions or locations where passenger and/or vehicle pickups/drop-offs occur) based on probe trajectory data.

According to one embodiment, a method for identifying a transportation transition region from probe trajectory data comprises determining a geographic area that encompasses a point of interest and an off-road region associated with the point of interest. The method also comprises retrieving one or more probe trajectories that intersect the geographic area. The method further comprises segmenting the one or more probe trajectories into a plurality of segments (e.g., e.g., based on the kinematics of the trajectories and/or a transportation transition activity). The plurality of segments, for instance, includes one or more on-road segments, one or more off-road segments, or a combination thereof. The method also comprises processing the plurality of segments to identify one or more transition segments that include a transition involving an on-road segment of the one or more on-road segments or an off-road segment of the one or more off-road segments. The method further comprises clustering one or more probe points of the one or more transition segments to identify the transportation transition region. The method further comprises providing the transportation transition region as an update to a geographic database, a mapping database, a navigation database, or a combination thereof.

According to another embodiment, an apparatus for identifying a transportation transition region from probe trajectory data comprises at least one processor, and at least one memory including computer program code for one or more computer programs, the at least one memory and the computer program code configured to, with the at least one processor, cause, at least in part, the apparatus to determine a geographic area that encompasses a point of interest and an off-road region associated with the point of interest. The apparatus is also caused to retrieve one or more probe trajectories that intersect the geographic area. The apparatus is further caused to segment the one or more probe trajectories into a plurality of segments (e.g., based on the kinematics of the trajectories and/or a transportation transition activity). The plurality of segments includes one or more on-road segments, one or more off-road segments, or a combination thereof. The apparatus is also caused to process the plurality of segments to identify one or more transition segment that includes a transition involving an on-road segment of the one or more on-road segments or an off-road segment of the one or more off-road segments. The apparatus is further caused to cluster one or more probe points of the one or more transition segments to identify the transportation transition region. The apparatus is further caused to provide the transportation transition region as an update to a geographic database, a mapping database, a navigation database, or a combination thereof.

According to another embodiment, a non-transitory computer-readable storage medium for identifying a transportation transition region from probe trajectory data carries one or more sequences of one or more instructions which, when executed by one or more processors, cause, at least in part, an apparatus to determine a geographic area that encompasses a point of interest and an off-road region associated with the point of interest. The apparatus is also caused to retrieve one or more probe trajectories that intersect the geographic area. The apparatus is further caused to segment the one or more probe trajectories into a plurality of segments (e.g., based on the kinematics of the trajectories and/or a transportation transition activity). The plurality of segments includes one or more on-road segments, one or more off-road segments, or a combination thereof. The apparatus is also caused to process the plurality of segments to identify one or more transition segments that include a transition involving an on-road segment of the one or more on-road segments or an off-road segment of the one or more off-road segments. The apparatus is further caused to cluster one or more probe points of the one or more transition segments to identify the transportation transition region. The apparatus is further caused to provide the transportation transition region as an output.

According to another embodiment, an apparatus for identifying a transportation transition region from probe trajectory data comprises means for determining a geographic area that encompasses a point of interest and an off-road region associated with the point of interest. The apparatus also comprises means for retrieving one or more probe trajectories that intersect the geographic area. The apparatus further comprises means for segmenting the one or more probe trajectories into a plurality of segments (e.g., based on the kinematics of the trajectories and/or a transportation transition activity). The plurality of segments includes one or more on-road segments, one or more off-road segments, or a combination thereof. The apparatus also comprises means for processing the plurality of segments to identify one or more transition segments that include a transition involving an on-road segment of the one or more on-road segments or an off-road segment of the one or more off-road segments. The apparatus further comprises means for clustering one or more probe points of the one or more transition segments to identify the transportation transition region. The apparatus further comprises means for providing the transportation transition region as an update to a geographic database, a mapping database, a navigation database, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of automatically identifying off-road pickup/drop-off locations or other transportation transition regions based on probe trajectory data, according to one embodiment;

FIGS. 2A-2H are diagrams illustrating an example use case for automatically identifying off-road pickup/drop-off locations based on probe trajectory data, according to one embodiment;

FIG. 3 is a diagram of the components of a mapping platform configured to automatically identify off-road pickup/drop-off locations or other transportations regions based on probe trajectory data, according to one embodiment;

FIG. 4 is a flowchart of a process for automatically identifying off-road pickup/drop-off locations or other transportation transition regions based on probe trajectory data, according to one embodiment;

FIGS. 5A-5F are diagrams of example user interfaces capable of automatically identifying off-road pickup/drop-off locations based on probe trajectory data, according to one embodiment;

FIG. 6 is a diagram of a geographic database, according to one embodiment;

FIG. 7 is a diagram of hardware that can be used to implement an embodiment;

FIG. 8 is a diagram of a chip set that can be used to implement an embodiment; and

FIG. 9 is a diagram of a mobile terminal (e.g., handset or vehicle or part thereof) that can be used to implement an embodiment.

### DESCRIPTION OF SOME EMBODIMENTS

Examples of a method, apparatus, and computer program for automatically identifying off-road pickup/drop-off locations or other transportation transition regions based on probe trajectory data are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

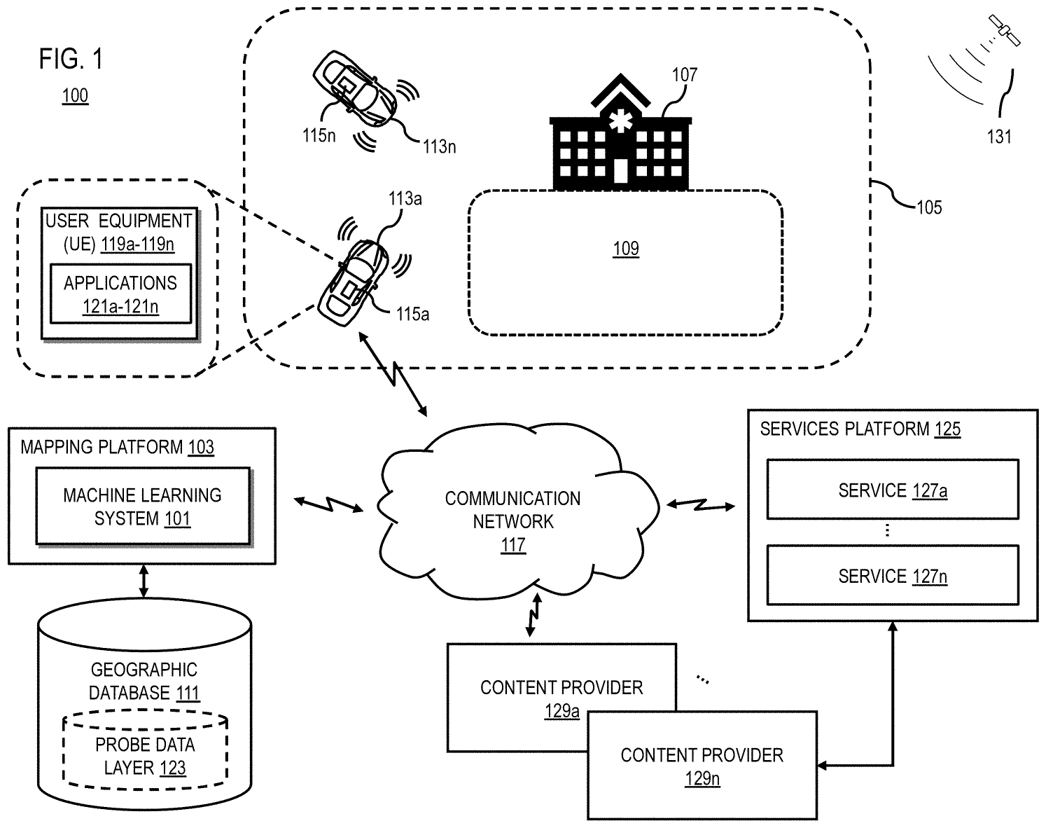

FIG. 1 is a diagram of a system capable of automatically identifying off-road pickup/drop-off locations or other transportation transition regions based on probe trajectory data, according to one embodiment. As mentioned above, providing navigation support to users and operators of ride hailing and/or ride sharing services or any other transportation services (e.g., vehicle sharing services such as shared bicycles, scooters, etc.) is an important function for mapping service providers. Ride-hailing companies are particularly interested in quickly and accurately identifying locations (e.g., on-road and off-road) where they need to navigate to pickup and drop-off passengers (e.g., to minimize operating costs such as fuel, labor, and/or the number of vehicles being used or available to customers). For example, in the absence of accurate pickup/drop-off location information, a ride hailing vehicle may have to waste time and fuel driving around looking for the actual location and/or the passenger, and during this time, the vehicle is unavailable to other paying customers. In some instances, the vehicle may have to pull over or even park to enable the driver or operator (e.g., of an autonomous vehicle) to contact a passenger that has scheduled a pickup, causing additional delay and inconvenience. Further, inaccurate localization (e.g., global positioning system (GPS) coordinates) may cause a ride hailing system or operator to switch pickup assignments among nearby ride hailing vehicles. In such instances, the wait time may unnecessarily increase, causing an inconvenience for both users and operators alike.

Current strategies for identifying pickup/drop-off locations are often based on taxis and/or the behavioral state of a vehicle. For example, one approach proposes a framework for identifying pickup/drop-off locations by clustering pickup/drop-off activity reported by taxis (e.g., trajectories or traces). However, this approach assumes pickup/drop-off locations as an attribute of a reported trajectory, which may reduce the accuracy of the identified location. Another approach clusters GPS points obtained from taxi traces to identify pickup/drop-off locations. The assumption in this approach is that taxi drivers tend to cluster around high demand areas (e.g., train stations, airports, etc.). Therefore, clustering the points over different time periods, results in pickup/drop-off points. However, emergence of such patterns is inherent to the source of the data (in this case taxis) and need not necessarily be present in trajectories generated by consumers' devices (e.g., a mobile device, a smartphone, etc.). Moreover, the clusters observed from taxi data may be biased towards the purpose of commuting. For example, people may likely take a taxi to and from an airport or a train station but may not take a taxi to and from a shopping mall, a gym, a hospital, or the like. Thus, relevant pickup/drop-off location-based information may be missing and/or require costly human interaction (e.g., human observation) to ensure the requisite high level of accuracy required by ride hailing services to ensure safe and efficient operation. Furthermore, when the pickup/drop-off activity is quick (i.e., there is no opportunity for lingering) patterns indicative of such activity may not be readily apparent and as such the accuracy of an identified location may be affected.

A further example approach proposes a method for inferring a behavioral state of a vehicle, which can be used in conjunction with a segmentation algorithm based on distance, time, and speed thresholds to identify parking places. However, this approach does not facilitate identification of the behavioral state of a vehicle in areas where the underlying road network does not exist (e.g., off-road). Moreover, the vehicle state probabilities as well as the transition probabilities must be known from historical data to infer and derive vehicle state sequences and such data may be missing or out-of-date, which may cause providers to make incorrect conclusions or decisions with respect to routing one or more ride hailing vehicles and/or require costly human interaction to ensure the requisite high level of accuracy. Accordingly, mapping service providers face significant technical challenges to quickly and accurately identify off-road pickup/drop-off locations in a cost-effective manner.

To address these problems, the system 100 of FIG. 1 introduces a capability to automatically identify off-road pickup/drop-off locations or any other transportation transition region based on probe trajectory data. A transportation transition region, for instance, refers to any geographic area or location where a user or passenger transitions from one mode of transportation to another or she or he transitions from one transportation service to another. For example, in the case of a ride-hailing service, the transportation transition region refers to a geographic area where a passenger “transitions” from being a pedestrian to being a vehicle passenger (e.g., in the case of a pick-up location or region) or vice-versa (e.g., in the case of a drop-off location or region). In one instance, a transportation transition region may be located within and/or adjacent to a parking lot associated with a POI. Although the various embodiments are described with respect to transportation transition regions that are pick-up/drop-off locations, it is contemplated that the embodiments are also applicable to any other type of transportation-related transition including, but not limited to: changing from one transportation service to another (e.g., moving from one ride-hailing service to another); changing from one mode of transport to another mode of transport (e.g., changing from a ride-hailing vehicle to a public transport vehicle such as a bus or a train); changing from one vehicle to another vehicle (e.g., moving from a car limited to a first service area to another car limited to a second service area along a user's route); and/or the like. As such, an off-road pickup/drop-off location or any other transportation transition region may include a parking lot, a park, a lake, a building, and/or any cartographic feature where a transition between one mode of transport to another mode of transport is possible.

In one embodiment, the system 100 uses the kinematics (e.g., motion and timing) of a probe trajectory combined with the underlying road network to automatically identify the off-road pickup/drop-off locations. By way of example, a probe trajectory is a time-ordered set of probe data from a probe device (e.g., time-stamped locations sensed and reported by a probe device identified by a unique probe identifier) which shows the movement of the probe device. The kinematics, for instance, can be used to segment the probe trajectory and then match the segments to probable transportation transition regions based on the corresponding kinematics associated with the transition activity that is expected to occur in the transition regions or segments. For example, when the transition activity is a passenger pick-up or drop-off, the kinematics of the activity can represent the time and area over which the pick-up or drop-off generally occurs. In an example scenario in which an average pick-up or drop-off takes approximately 1 minute over a 5 meter by 50 meter area, this time value and area value can be used as segmentation criteria to segment a probe trajectory of interest into segments that may correspond to the transition activity (e.g., also referred to as transition segments). In one embodiment, once one or more trajectories are segmented to determine these transition segments, the probe points in the transition segments are clustered, and then the boundaries (e.g., a convex hull) delineated by the probe points in each cluster are used to identify the transportation transition areas. For example, the clustering can be performed based on the locations of the probe points or any other selected clustering criteria (e.g., based on any other characteristic or combination of characteristics of the probe points such as but not limited to speed, direction, etc.).

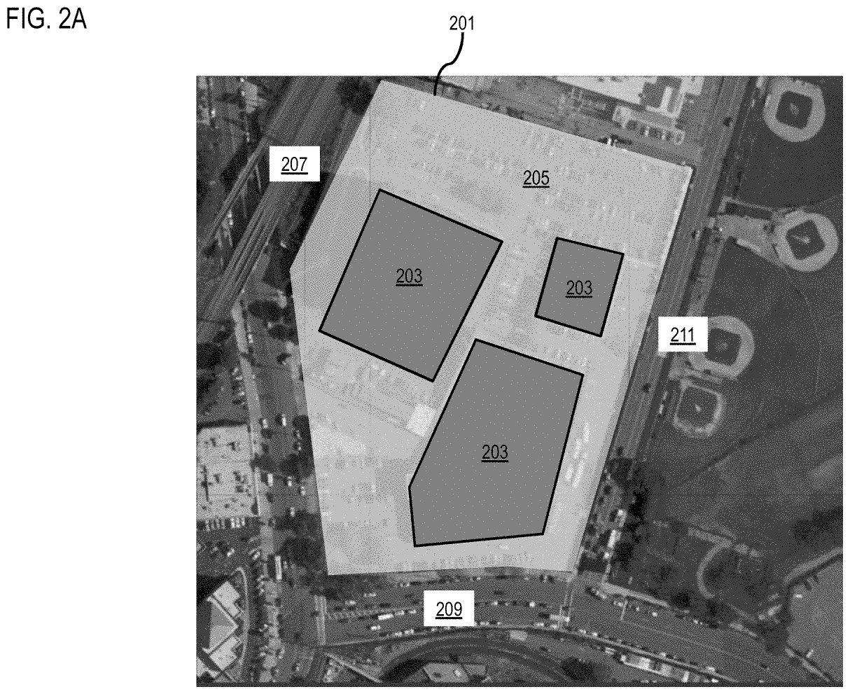

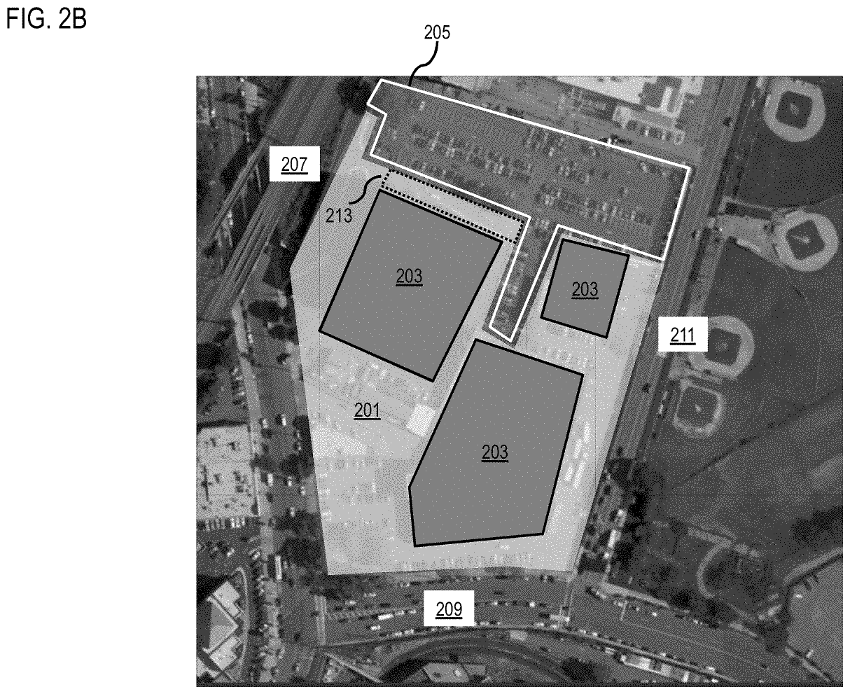

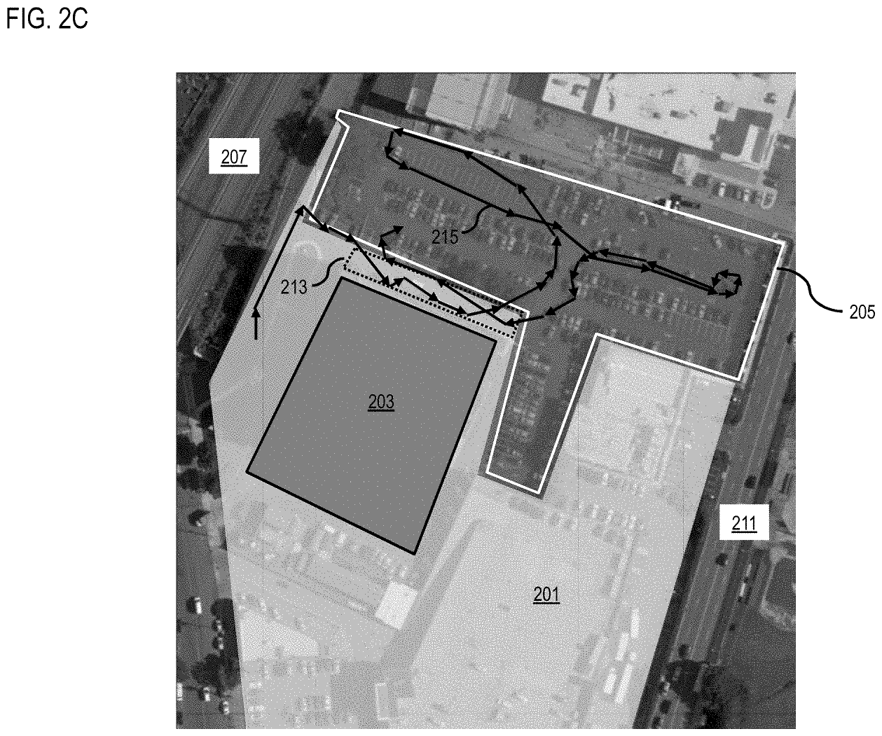

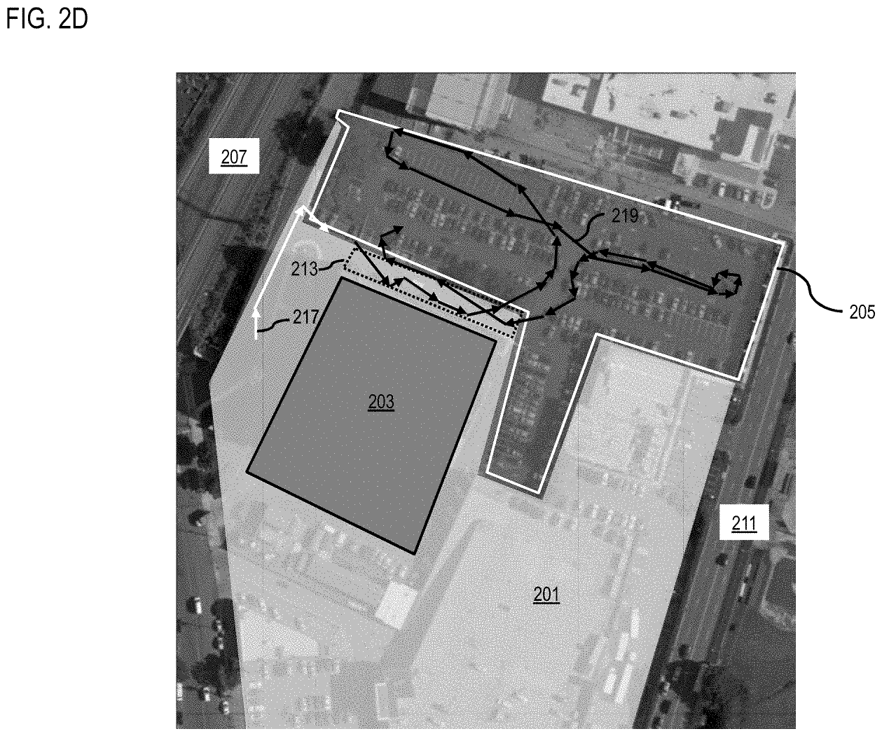

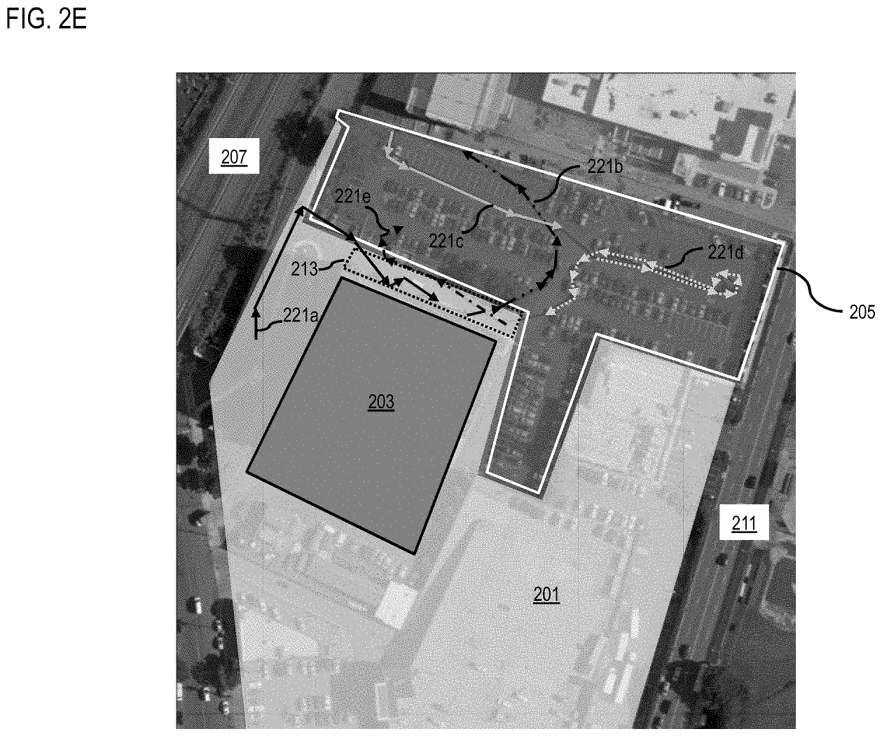

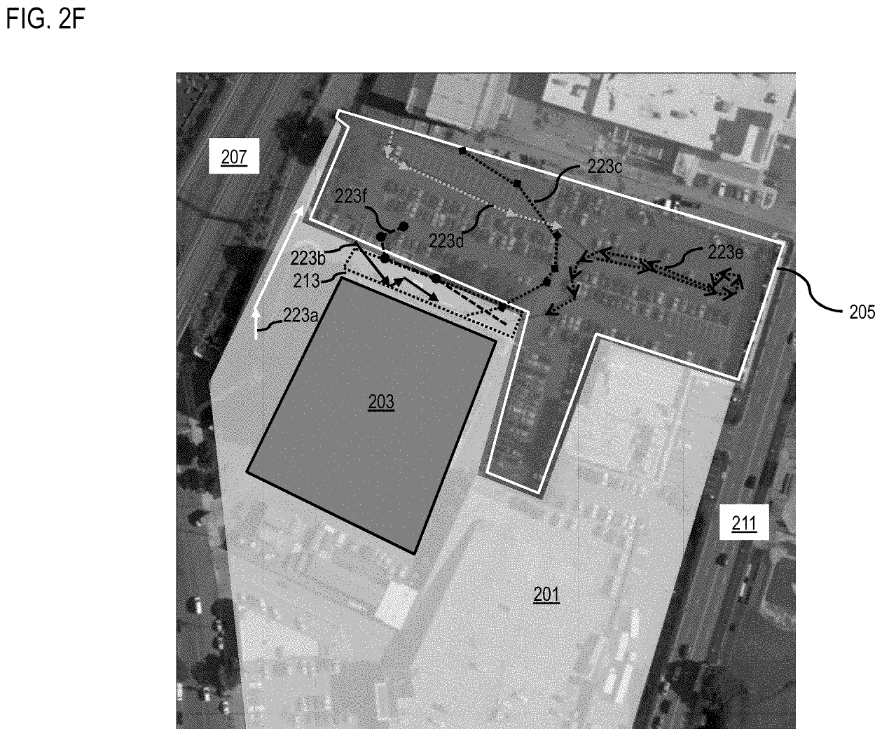

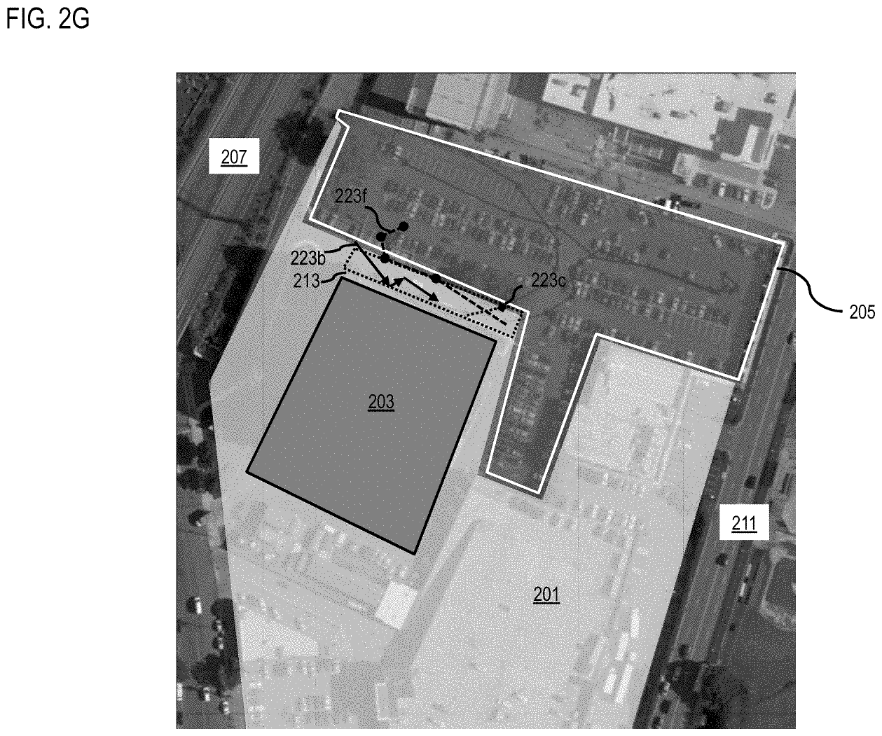

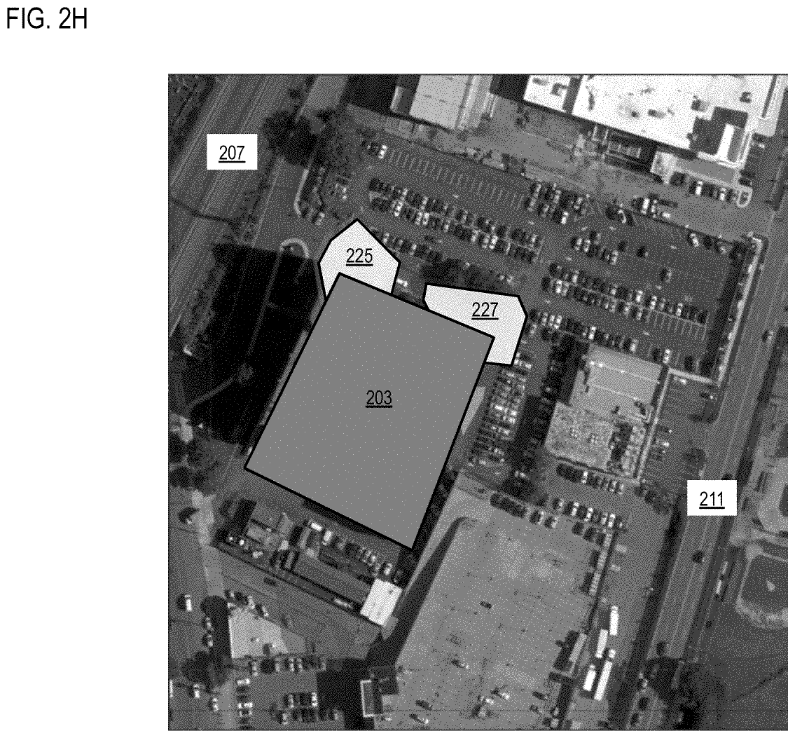

In one embodiment, the system 100 uses as an input (e.g., for the machine learning system 101 of the mapping platform 103) a geographic boundary 105 (e.g., a polygon) that includes a point of interest (POI) 107 (e.g., a hospital, a shopping mall, an airport, etc.) and an associated off-road area or region 109. By way of example, the associated off-road area or region may be an area where an underlying road network does not exist (e.g., a parking lot) and/or comprise a transportation transition region as described above. An example of this input is illustrated in FIG. 2A, where a candidate polygon 201 includes a POI 203 (e.g., a shopping center) and an associated parking lot 205. In this example, the polygon 201 is bounded by roads 207, 209, and 211. In one instance, the system 100 also uses as an input (e.g., for the machine learning system 101) the geometry of the parking lot geometry 109 to subsequently identify the <off-road> to <parking lot> transition segments. An example of this input is illustrated in FIG. 2B, where the parking lot 205 is delineated from the polygon 201 and the transportation transition region 213. In one instance, the off-road region may include any areas that are navigable within the geographic boundary 105 (e.g., by a vehicle, a bike, a scooter, walking, running, etc.) including, but not limited to the off-road region 109 and/or that are geographically distinct from any vehicular roads or routes that may be connected to the geographic boundary 105 (e.g., roads 207, 209, and 211). In one embodiment, the system 100 may extract the geographic boundary 105, the off-road area 109, and/or the functional class of each road connected to the geographic boundary from any data source available to the system 100 including, but not limited to, the geographic database 111.

In one embodiment, the system 100 identifies a set of candidate trajectories that intersect the geographic boundary 105 en route to the off-road area 109. In one instance, a trajectory is a time ordered sets of probe data from one probe ID which shows the movement of a probe device. In one embodiment, the system 100 identifies the candidate trajectories by collecting probe data from one or more vehicles 113a-113n (also collectively referred to as vehicles 113) (e.g., standard vehicles, autonomous vehicles, heavily assisted driving (HAD) vehicles, semi-autonomous vehicles, etc.) traveling through the geographic boundary 105. In one instance, the vehicles 113 include one or more vehicle sensors 115a-115n (also collectively referred to as vehicle sensors 115) (e.g., GPS sensors) and have connectivity to the mapping platform 103 via the communication network 117. Though depicted as automobiles, it is contemplated the vehicles 113 can be any type of ride hailing or ride sharing vehicles manned or unmanned (e.g., cars, trucks, buses, vans, motorcycles, scooters, bicycles, drones, etc.).

In one instance, the probe data may be reported as probe points, which are individual data records collected at a point of time that records telemetry data for that point in time. A probe point can include attributes such as: (1) probe ID, (2) longitude, (3) latitude, (4) heading, (5) speed, and (6) time. An example probe trajectory is illustrated in FIG. 2C, where the trajectory 215 (e.g., derived from a vehicle 113) intersects the polygon 201 and the transportation transition region 213 en route to the parking lot 205 from the road 207. In this example, the trajectory 215 includes the following transitions: (a) <on-road> (e.g., road 207) to <off-road> (e.g., transportation transition region 213); (b)<off-road> to <parking lot> (e.g., parking lot 205); and (c)<parking lot> to <off-road>.

In one embodiment, the system 100 can also collect probe data from one or more user equipment (UE) 119a-119n (also collectively referenced to herein as UEs 119) associated with a vehicle 113 (e.g., an embedded navigation system), a user or a passenger of a vehicle 113 (e.g., a mobile device, a smartphone, etc.), or a combination thereof. In one instance, the UEs 119 may include one or more applications 121a-121n (also collectively referred to herein as applications 121) (e.g., a navigation or mapping application, a ride hailing booking or reservation application, etc.). In one embodiment, the probe data collected by the vehicle sensors 115, the UEs 119, or a combination thereof may be stored in the probe data layer 123 of the geographic database 111, the geographic database 111, or a combination thereof.

In one embodiment, the system 100 map matches each of the candidate trajectories (e.g., trajectory 215) to generate on-road/off-road segments of each trajectory. By way of example, a segment in this instance refers to a sub-trajectory and not the mathematical line segment. In one instance, the system 100 performs the probe trajectory segmentation using map matching confidence to classify the types of resulting trajectory segments such that on-road segments (e.g., on the road 207) and off-road segments (e.g., within the transportation transition region 213 and/or the parking lot 205) are sufficiently homogeneous. By way of example, the system 100 can determine the map matching confidence by processing the trajectory (e.g., trajectory 215) using any map matching system (e.g., path-based map matchers, point-based map matchers, etc.). For example, the system 100 can classify trajectory segments with high map matching confidence (e.g., above a threshold value) as being on a road (e.g., road 207) because they are likely to have been correctly map matched to one or more road segments of a digital map (e.g., the geographic database 111). Conversely, the system 100 can classify trajectory segments with low map matching confidence (e.g., below a threshold value) as being off-road (e.g., the transportation transition region 213 and/or the parking lot 205) because they are not likely to match any road segment of the digital map. An example of this map matching and on-road/off-road trajectory segmentation is illustrated in FIG. 2D, where the candidate trajectory 215 is segmented into on-road segments 217 (e.g., represented as white) and off-road segments 219.

In one instance, during the map matching or segmentation process, the system 100 may not be able to classify one or more trajectory segments into known types with a target level of confidence. Accordingly, the system 100 may classify some trajectory segments as unknown types. In one embodiment, the system 100 can optionally merge these unknown types into one of the known types (e.g., on-road or off-road) based on their co-occurrence with known trajectory segment types. For example, if an unknown trajectory segment occurs immediately before, after, or between an on-road trajectory segment, the unknown trajectory can be merged with the co-occurring on-road trajectory. This can be done similarly for co-occurrence with off-road trajectory segments or trajectory segments of any known type. In this way, the system 100 can merge unknown trajectory segments into known segments before segmenting the candidate trajectories using a monotone segmentation framework, as described in the subsequent section.

In one embodiment, the system 100 further segments or sub-segments the on-road segments (e.g., segments 217) and the off-road segments (e.g., segments 219) of the candidate trajectory (e.g., trajectory 215) using a monotone segmentation framework. In one instance, the system 100 segments each candidate trajectory (e.g., trajectory 215) using a difference criterion (for time) and a disk criteria (for location). In one embodiment, the system 100 performs the monotone segmentation using as an input (e.g., for the machine learning system 101) the following segmentation parameters: (a) a difference criteria threshold for segmenting the candidate trajectory based on time; and (b) a disk criteria threshold for segmenting the candidate trajectory based on location. In one instance, the difference criteria threshold is the upper bound for the difference between the max timestamp and the min timestamp within a trajectory segment and the disk criteria threshold is the upper bound for the radius of a disk that can cover all points of the trajectory segment. In one embodiment, the system 100 experimentally or iteratively determines (e.g., using the machine learning system 101) the threshold for each criteria such that the segmentation parameters best represent (e.g., exceed a threshold of similarity) the kinematics of a pickup/drop-off activity, namely the time spent by a device (e.g., a vehicle 113 and/or a UE 119) in a location of certain radius (e.g., within the transportation transition region 213). In one instance, it is contemplated that the inclusion of the time-based criterion in the monotone segmentation framework can better classify quick activity segments compared to just using a disk criterion that may inadvertently misclassify such short segments. An example of the monotone segmentation of the on-road segments 217 and the off-road segments 219 of the candidate trajectory 215 by the system 100 is illustrated in FIG. 2E. In this example, each graphic representation denotes a segment (e.g., segments 221a-221e) such that all points in the segment can be covered by a disk of a given radius.

In one instance, the system 100 combines the segmentation criteria using a start/stop matrix to generate segments that satisfy map matching and monotone segmentation criteria based on time and location (e.g., on-road, off-road, location-based, and time-based). By way of example, a start-stop matrix stores the relation between a trajectory (e.g., trajectory 215) and a criterion (e.g., a function that maps a sub-trajectory (candidate segment) to true or false). In one instance, it is contemplated that the combination or merger of segmentation criteria enables the inclusion of a percentage of outliers (e.g., resulting from GPS noise) per segment that would help the segmentation process by reducing the number of consecutive segments. An example of this combined segmentation criteria is illustrated in FIG. 2F, where the system 100 combines the on-road segments 217 and the off-road segments 219 of FIG. 2D with the monotone criteria segments 221a-221e of FIG. 2E to form the combined segments 223a-223f.

In one embodiment, the system 100 uses attributes from the underlying road network (e.g., stored in or accessible via the geographic database 111) to identify the following transition segments of the candidate trajectory (e.g., trajectory 215): (a) <on-road> to <off-road> to <parking lot>; (b)<parking lot> to <off-road> to <on-road>; and (c)<on-road> to <off-road> to <on-road>. In one instance, the system 100 then records (e.g., in the probe data layer 123, the geographic database 111, or a combination thereof) the off-road segments that are part of a transition (e.g., segments 223b, 223c, and 223f), as depicted in FIG. 2G. In one embodiment, the system 100 records all such off-road transition segments for all candidate trajectories that intersect the geographic boundary 105 (e.g., polygon 201).

In one instance, the system 100 clusters the probe points in the off-road segments in all transition segments (e.g., segments 223b, 223c, and 223e) and then generates a convex hull (e.g., convex hulls 225 and 227) enclosing the clustered probe points such that the convex hull represents an off-road pickup-drop-off location, as depicted in FIG. 2H. In embodiment, the system 100 outputs the off-road pickup/drop-off location to a driver or operator of a vehicle 113 (e.g., via a UE 119) and/or a pedestrian (e.g., a UE 119) in connection with one or more ride-hailing operations.

In one embodiment, the machine learning system 101 (e.g., a support vector machine (SVM), a neural network, a decision tree, etc.) learns or is trained using the inputs: (1) a candidate polygon (e.g., polygon 201); (2) a parking lot geometry (e.g., parking lot 205) inside the polygon; (3) segmentation parameters (e.g., as illustrated in FIGS. 2D-2F); and (4) clustering parameters (e.g., as illustrated in FIGS. 2G and 2H) to automatically output a resultant convex hull as an off-road pickup/drop region. Consequently, the system 100 can quickly and accurately identify off-road pickup/drop-off locations based on probe trajectory data in a cost-effective manner.

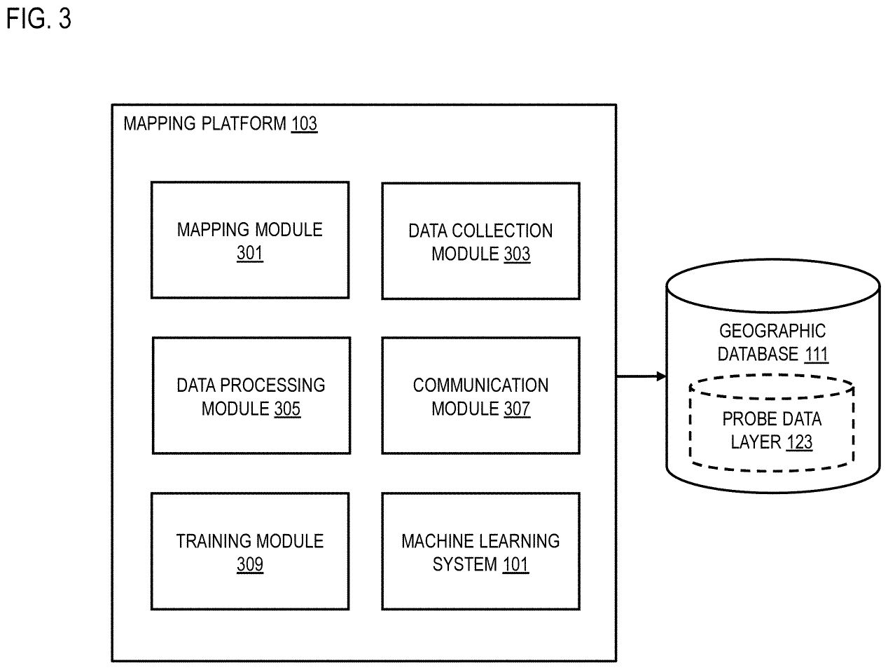

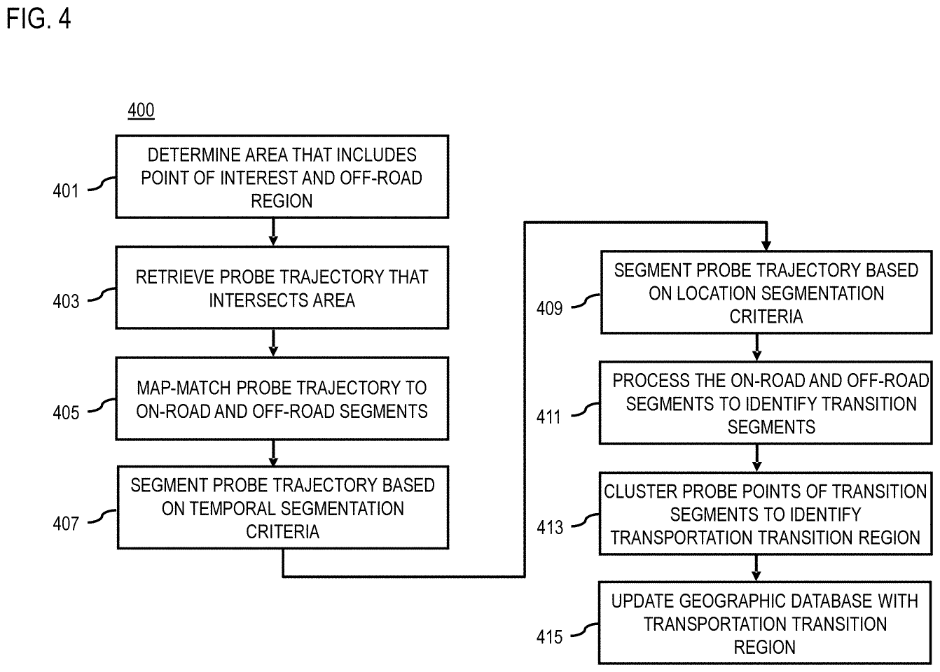

FIG. 3 is a diagram of the components of the mapping platform 103, according to one embodiment. By way of example, the mapping platform 103 includes one or more components for automatically identifying off-road pickup/drop-off locations or other transportation transition regions based on probe trajectory data, according to the various embodiments described herein. It is contemplated that the functions of these components may be combined or performed by other components of equivalent functionality. In one embodiment, the mapping platform 103 includes a mapping module 301, a data collection module 303, a data processing module 305, a communication module 307, a training module 309, and the machine learning system 101, and has connectivity to the geographic database 111 including the probe data layer 123. The above presented modules and components of the mapping platform 103 can be implemented in hardware, firmware, software, or a combination thereof. Though depicted as a separate entity in FIG. 1, it is contemplated that the mapping platform 103 may be implemented as a module of any other component of the system 100. In another embodiment, the mapping platform 103 and/or the modules 301-309 may be implemented as a cloud-based service, local service, native application, or combination thereof. The functions of the mapping platform 103, the machine learning system 101, and/or the modules 301-309 are discussed with respect to FIG. 4.

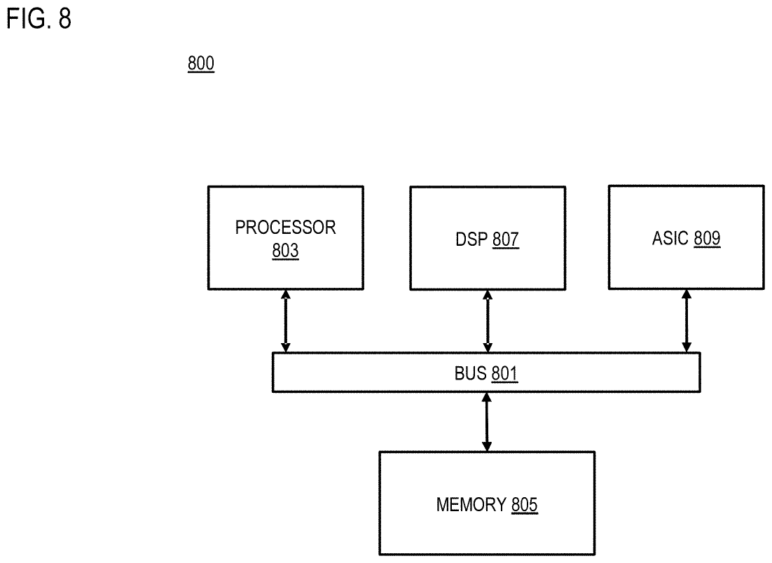

FIG. 4 is a flowchart of a process 400 for automatically identifying off-road pickup/drop-off locations or other transportation transition regions based on probe trajectory data, according to one embodiment. In various embodiments, the mapping platform 103, the machine learning system 101, and/or any of the modules 301-309 may perform one or more portions of the process 400 and may be implemented in, for instance, a chip set including a processor and a memory as shown in FIG. 8. As such, the mapping platform 103, the machine learning system 101, and/or the modules 301-309 can provide means for accomplishing various parts of the process 400, as well as means for accomplishing embodiments of other processes described herein in conjunction with other components of the system 100. Although the process 400 is illustrated and described as a sequence of steps, its contemplated that various embodiments of the process 400 may be performed in any order or combination and need not include all the illustrated steps.

In step 401, the mapping module 301 determines a geographic area, wherein the geographic area encompasses a point of interest and an off-road region associated with the point of interest. By way of example, the geographic area may be a polygon, a zone, a perimeter, and/or a boundary set or assigned by the mapping module 301 around, surrounding, or circumscribing the POI (e.g., a hospital, a shopping mall, an airport, an office building, an apartment complex, a stadium, etc.). In one embodiment, the mapping module 301 can determine the geographic area, the POI, and/or the off-road region from any data source available to the system 100 including, but not limited to, the geographic database 111. In one instance, the mapping module 301 may determine the geographic area based on one or more roads that intersect or that are connected to the off-road region. In other words, in one instance, the geographic area represents an off-road region apart from but potentially bound by a road network.

In one embodiment, an off-road region may be any region or area wherein the underlying road network does not exist and/or any geographic area or location where a user or passenger transitions from one mode of transportation to another or she or he transitions from one transportation service to another (i.e., a transportation transition region). For example, an off-road region may be an area where an individual may be safely picked up/dropped off by a vehicle (e.g., a vehicle 113) and/or where such pickup/drop off activity ordinarily or historically occurs (e.g., a parking lot, a shopping mall, a hospital, an airport, etc.). In one instance, an off-road region (e.g., a parking lot, a park, a lake, an office, or apartment building) may be any region that may be characterized or represented by a different map regime relative to a road network. An off-road region, for example, may be any region or area characterized by or that permits a behavioral change or transition of movement (e.g., a first vehicle to a second vehicle, a vehicle to a scooter or vice-versa, a vehicle to walking or vice-versa, walking to a scooter or vice-versa, walking to a bicycle or vice-versa, etc.). In one instance, an off-road region may be characterized by a mix of transportation relative to on-road regions. In one embodiment, on-road refers to one of the four major road function classifications: interstates, other arterials, collectors, and local roads such that vehicular transit is the primary mode of transportation on such roads and that individuals may not ordinarily or safely be picked up/dropped off on such roads (albeit separate and apart from the case of an emergency).

In step 403, the data collection module 303 retrieves one or more probe trajectories that intersect the geographic area. By way of example, a probe trajectory is a time ordered sets of probe data from one probe ID which shows the movement of a probe device (e.g., a vehicle 113, a UE 119, or combination thereof). In one embodiment, a probe trajectory intersects the geographic area when the probe device (e.g., a vehicle 113) crosses from an on-road regime to an off-road regime and in doing so crosses a boundary of the geographic area.

In step 405, the data processing module 305 initiates a process to segment the retrieved probe trajectories by identifying which portions of the trajectories occur on-road and which portions occur off-road. On-road segments, for instance, are portions of the probe trajectory that occur or align to roads that are used for travel as opposed to off-road segments which are roads or other areas accessible by a vehicle but are not used for travel (e.g., parking lots, parking areas, loading zones, stopping areas, etc.). In one embodiment, the data processing module 305 can use mapping data (e.g., the geographic database 111) as its data source for classifying whether a given road segment is an on-road or off-road segment. In other words, the geographic database 111 can store data indicating whether a particular road or segment is an on-road or off-road segment. Accordingly, in one embodiment, the mapping module 301 map-matches the plurality of probe trajectories or segments thereof to digital map data to determine the one or more on-road segments, the one or more off-road segments, or a combination thereof of the probe trajectories. By way of example, the mapping module 301 may map match the plurality of segments using map matching confidence as described above to classify the types of the resulting trajectory segments or the mapping module 301 may use any map matching system (e.g., path-based map matchers, point-based map matchers, etc.) to differentiate between trajectories associated with on-road activity and trajectories that are associated with off-road activity (e.g., picking up or dropping off of a passenger using a ride hailing service).

In one embodiment, after identifying the on-road and off-road portions of the probe trajectories, the data processing module 305 segments the one or more trajectories into one or more segments, wherein the plurality of segments include the one or more on-road segments, one or more off-road segments, or a combination thereof (e.g., based on the map-matching above). The segmentation can be based on segmentation criteria that are determined from the kinematics of the transportation transition activity of interest (e.g., picking up or dropping off vehicle passengers, boarding a bus or a train at a station, accessing a shared vehicle such as a scooter/bicycle/etc., and/or the like). Kinematics refers, for instance, to location parameters, temporal parameters, etc. that characterize a given transportation transition activity or a process for performing the activity. For example, when a taxi or other shared vehicle performs a transportation transition activity such as picking up or dropping off a passenger, the location parameter can describe the geographic area or location over which the pick-up/drop-off occurs, and the temporal parameter can describe how long the vehicle lingers at a location while picking up or dropping off passengers. These parameters can then be used as the segmentation criteria or as inputs for determining/calculating the segmentation criteria.

In one embodiment, the data processing module 305 can perform a monotone segmentation based on the one or more segmentation criteria. By way of example, a criterion is monotone if for any sub-trajectory or segment of the candidate trajectory, if a sub-trajectory satisfies the criterion, then any other sub-trajectory or segment of the trajectory also satisfies this criterion. As discussed above, the one or more segmentation criteria can include a temporal criterion, a location criterion, or a combination thereof.

Accordingly, in step 407, the data processing module 305 can segment the probe trajectories based on the temporal criterion. The temporal criterion, for instance, can be based on a duration of a transportation transition activity determined from the kinematics of the activity. This kinematic activity duration value can then be used to determine a temporal segmentation criterion that segments the probe trajectories based on the portion of the trajectories (e.g., sub-trajectories) that cover time slices corresponding to or otherwise based on the kinematic activity duration. In one embodiment, the temporal segmentation is based on a difference between the maximum timestamp and the minimum time stamp within a segment such that difference is based on the kinematic activity duration.

In step 409, in addition to or as an alternate to step 407, the data processing module 305 can segment the probe trajectories based on a location segmentation criterion. As with the temporal segmentation criterion, the location criterion can be based on the kinematics of the transportation transition activity of interest. In this case, the location criterion can be based on the geographic area or extent over which the transportation transition activity occurs. For example, in the use case of picking up or dropping off vehicle passengers, the area in which a vehicle stops and/or passengers linger for pick-up or drop-off can be determined from the kinematic activity location area (e.g., an area over which the activity generally occurs). It is contemplated that kinematic activity location area or corresponding location segmentation criterion can be designated using any type of boundary around a geographic area. For example, the data processing module 305 can use the radius of a disk (or any other selected boundary or shape) that can cover the one or more probe points of the segment corresponding to kinematic activity location area as the location segmentation criterion. The disk (or other designated area) may then be overlaid on to the probe trajectories to create sub-trajectories or trajectory segments that are cut at the boundaries of the disk. By way of example, the disk criterion is monotone in that if some sub-trajectory or segment can be covered by a fixed-size disk, then any part of the sub-trajectory can also be covered by such a disk (i.e., the same disk).

In one instance, the machine learning system 101 determines one or more thresholds for the one or more segmentation criteria based on kinematics of a transportation transition activity that is associated with the transportation transition region. In one embodiment, the training module 309 can train or condition the machine learning system 101 using a set of segmentation features or inputs (e.g., stored in and/or accessible via the geographic database 111) so that the machine learning system 101 may determine a threshold for the temporal criteria and a threshold for the location criteria such that the time spent in a location of certain radius best describes (i.e., exceeds a threshold of similarity) the kinematics of pickup/drop-off activity. In one instance, the training module 309 can train the machine learning system 101 to determine a best description by assigning weights, correlations, relationships, etc. among the features corresponding to relevant historical or ground truth data. In one embodiment, the training module 309 can continuously provide and/or update a machine learning module (e.g., a SVM, neural network, decision tree, etc.) of the machine learning system 101 during training using, for instance, supervised deep convolution networks or equivalents so that the machine learning system 101 may experimentally or iteratively determine both criteria such that the criteria exceeds a threshold of similarity or closeness.

In one embodiment, the transportation transition region includes a pick-up location, a drop-off location, or a combination thereof for a vehicle (e.g., a vehicle 113) to pick-up or drop-off a passenger. By way of example, a transportation transition region may refer to any geographic area or location where a user or passenger transitions from one mode of transportation to another or transitions from one transportation service to another. For example, in case of a ride-hailing service, the transportation transition region refers to a geographic area where a passenger “transitions” from being a pedestrian to being a vehicle passenger (e.g., in the case of a pick-up location or region) or vice-versa (e.g., in the case of a drop-off location). Although the various embodiments are described with respect to transportation transition regions that are pick-up/drop-off locations, it is contemplated that the embodiments are also applicable to any other type of transportation-related transition including, but not limited to: changing from one transportation service to another (e.g., moving from one ride-hailing service to another); changing from one mode of transport to another mode of transport (e.g., changing from a ride-hailing vehicle to a public transport vehicle such as a bus or a train); changing from one vehicle to another vehicle (e.g., moving from a car limited to a first service area to another car limited to a second service area along a user's route); and/or the like.

In one instance, the transportation transition activity includes picking-up/dropping off a passenger of a vehicle, transitioning between a first mode of transportation to a second mode of transportation, or a combination thereof. By way of example, the first mode and the second mode may be the same or different modes of transportation (e.g., a first vehicle and a second vehicle, a vehicle and a bike, or a vehicle and walking). In one embodiment, the transportation transition region may be where a ride sharing vehicle 113 may be left or accessible.

In step 411, the data processing module 305 processes the plurality of segments to identify one or more transition segments that include a transition involving an on-road segment of the one or more on-road segments or an off-road segment of the one or more off-road segments. By way of example, the one or more transition segments may include one of the following transitions or characteristics: (a)<on-road> to <off-road>; (b)<off-road> to <parking lot>; and (c) <parking lot> to <off-road> and the data processing module 305 may identify the one or more transition segments by matching one of the transitions or characteristics against a segment of the plurality. In one instance, <off-road> may be understood to mean the interstitial space or area between <on-road> and <parking lot> that enables a vehicle or an individual to move or travel between the two areas. In some instances, such an <off-road> area may be marked with a “no parking fire lane” sign.

In one embodiment, the mapping module 301 map-matches the plurality of segments to a geographic feature represented in digital map data, wherein the one or more transitions segments are further identified by the data processing module 305 based on the map-matching. In one instance, the geographic feature is a parking area. In another instance, the geographic feature may be a higher function class road such that the segments with low map matching confidence (e.g., below a threshold value) can be classified as being off-road and, therefore, either <off-road> or <parking lot> in this example. In one embodiment, the data processing module 305 combines the one or more on-road segments, the one or more off-road segments, or a combination thereof using a start/stop matrix, wherein the one or more transition segments are also identified based on the start/stop matrix. By way of example, as described above, a start-stop matrix stores the relationship between a trajectory and a criterion (e.g., a monotone segmentation criteria).

In step 413, the machine learning system 101 clusters one or more probe points of the one or more transition segments to identify the transportation transition region (e.g., a pickup/drop-off location). By way of example, the machine learning system 101 in connection with the training module 309 may employ an unsupervised learning method such as density-based clustering to identify distinctive groups/clusters that represent a high probability of a transportation transition region. In one embodiment, the data processing module 305 then generates a convex hull (e.g., convex hulls 225 and 227) of the clustered one or more probe points, wherein the transportation transition region is identified based on a portion of the geographic area delineated by the convex hull.

In step 415, the communication module 307 provides the transportation transition region as an update to a geographic database, a mapping database, a navigation database, or a combination thereof. By way of example, the communication module 307 may provide the transportation transition region (e.g., pickup/drop-off location) as an update to a geographic database (e.g., the geographic database 111) and/or a mapping or navigation database (e.g., used by an application 121 such as a ride hailing application) of a UE 119 associated with a vehicle 113 (e.g., an embedded navigation system) and/or a UE 119 associated with a passenger (e.g., a mobile device) to minimize the waiting time or delay associated with a ride hailing service operation (e.g., a pickup). In one embodiment, the communication module 307 may also provide the transportation transition region directly to a user as an output via an application 121 (e.g., a ride hailing application).

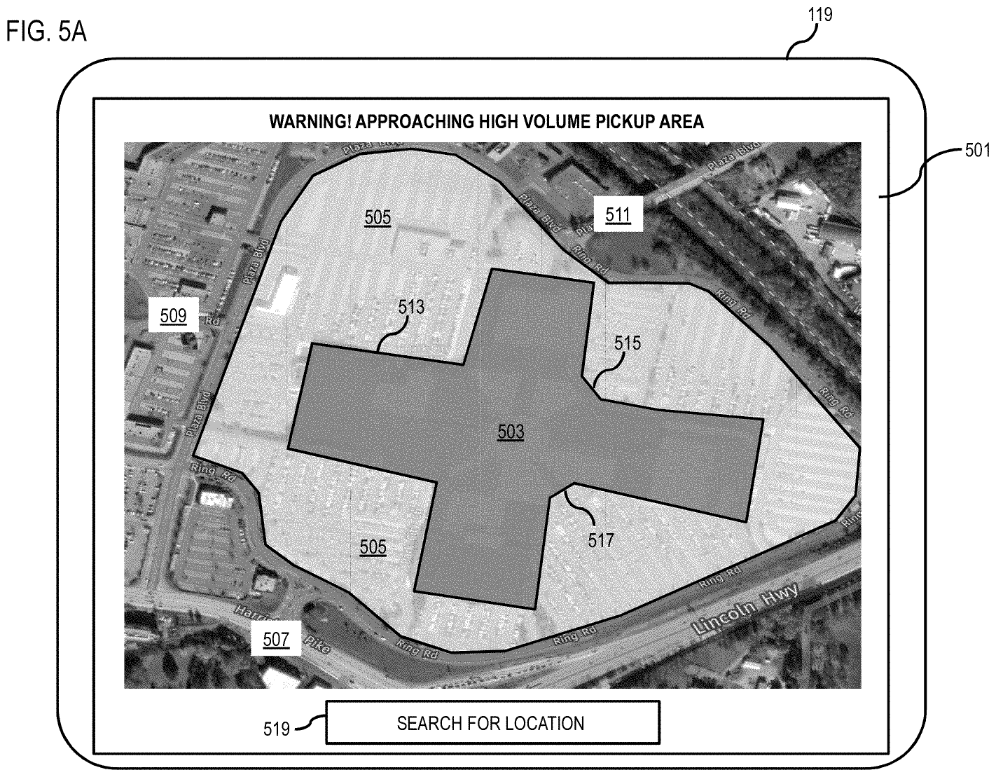

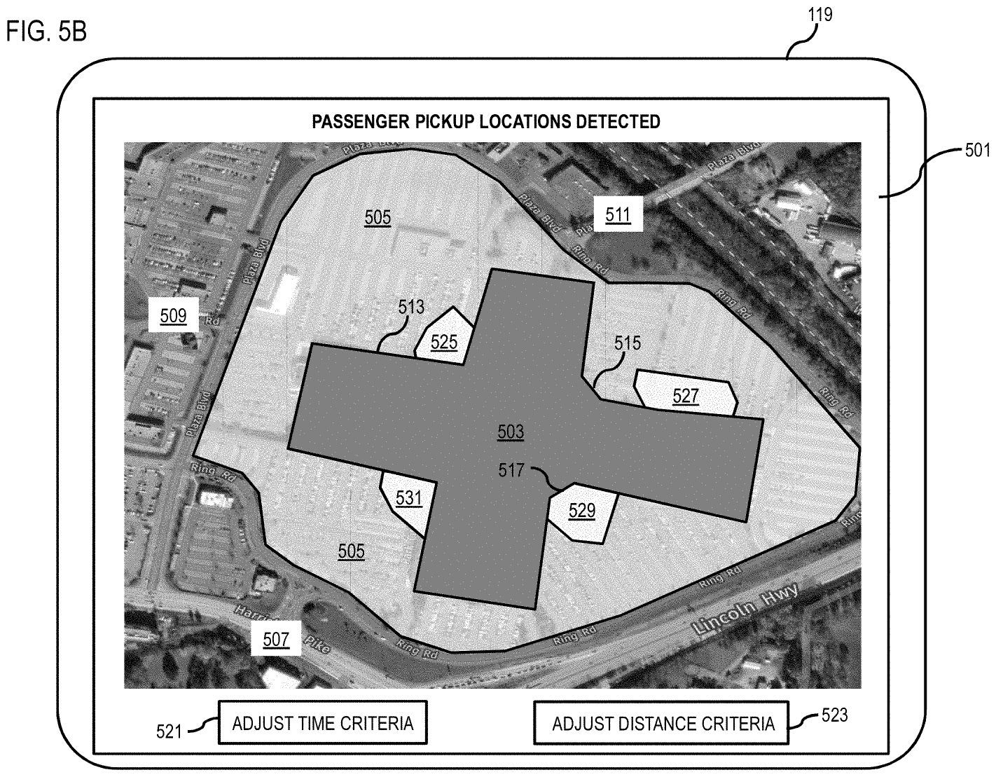

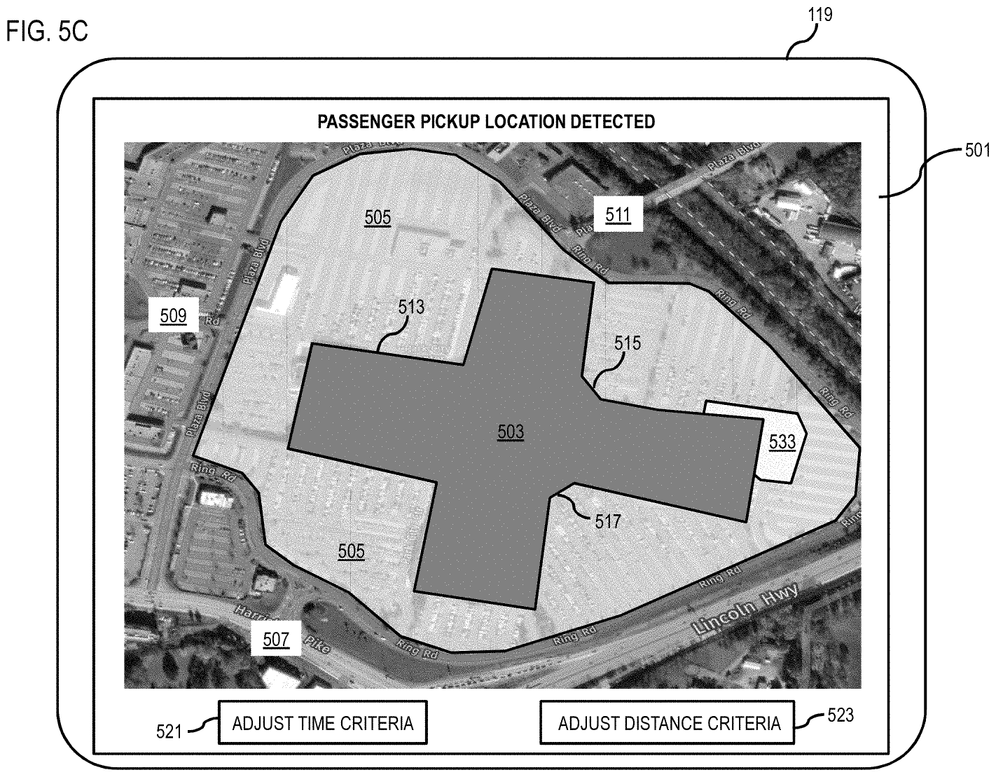

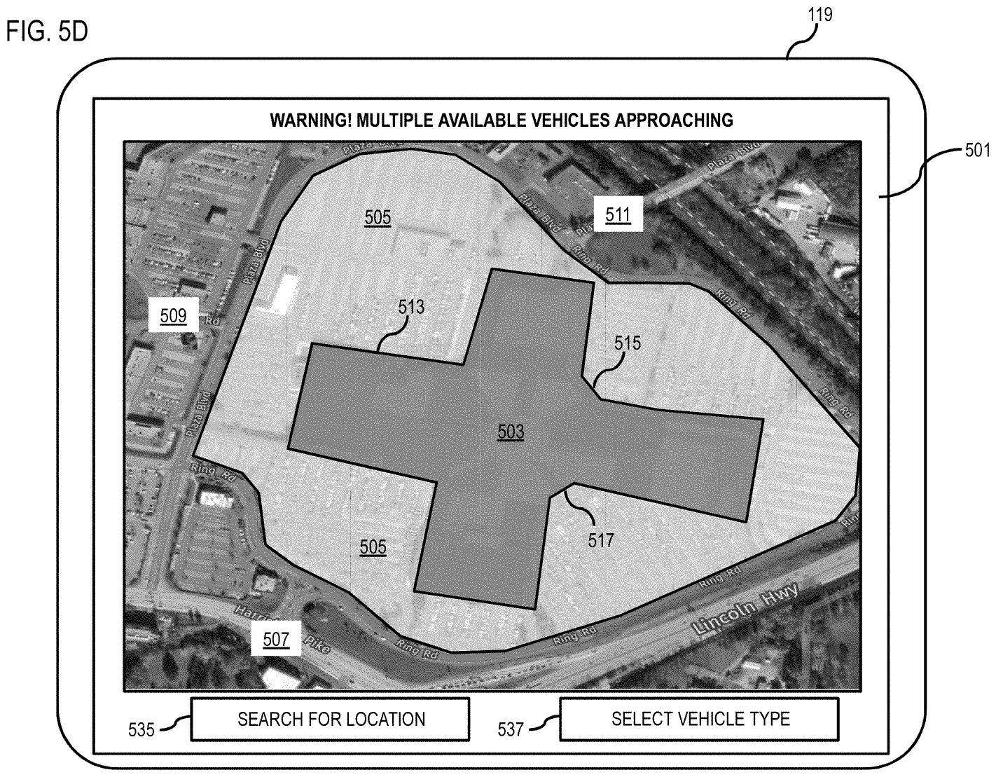

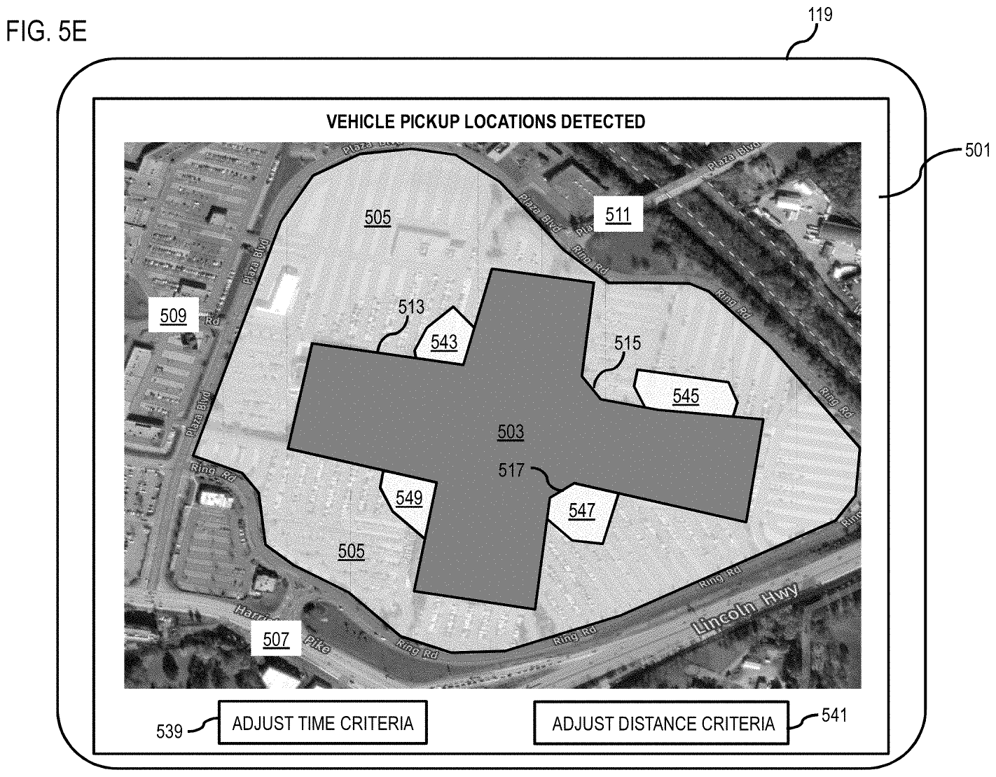

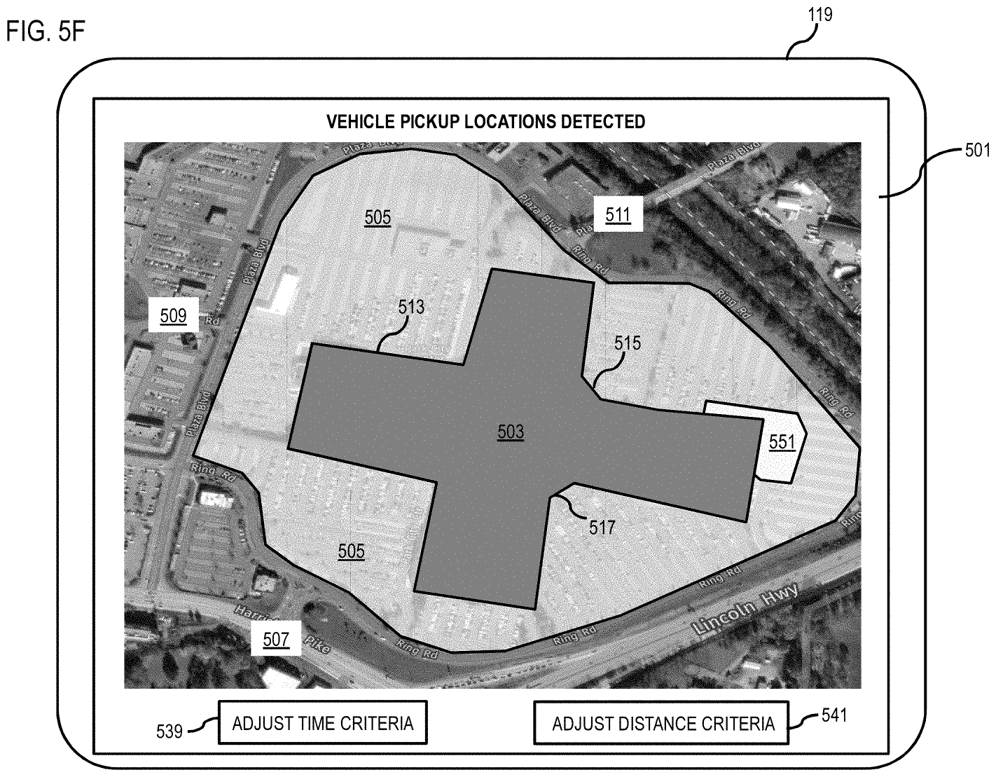

FIGS. 5A-5F are diagrams of example user interfaces capable of automatically identifying off-road pickup/drop-off locations based on probe trajectory data, according to one embodiment. In this example, a user interface (UI) 501 (e.g., a ride hailing booking or reservation application 121) is generated for a UE 119 (e.g., a mobile device, an embedded navigation system, a client terminal, etc.) that enables a driver or operator of a ride hailing vehicle 113 (e.g., an autonomous or semi-autonomous vehicle) to quickly and efficiently find a relatively high volume pickup location at the POI 503 (e.g., a large shopping center) and that likewise enables a user (e.g., a passenger and/or shopper) to quickly and efficiently identify a high volume pickup location at the POI 503 relative to her or his location within the POI 503. In other words, in both instances, the UI 501 can identify a pickup up location that enables the driver or operator of the ride hailing vehicle 113 and/or the user seeking a ride hailing vehicle 113 to minimize her or his waiting time. In one embodiment, the UI 501 can also allow a user to quickly and efficiently identify a pickup/drop-off location associated with one or more ride sharing vehicles (e.g., a scooter or a bicycle) relative to her or his location within the POI 503. Minimizing the time to pick-up a passenger or be picked up by a ride hailing vehicle 113 is particularly important in this instance where there are a number of vehicular entry points (e.g., entry points 507, 509, and 511) from the road network to the parking lot 505 and where there are a number of potential POI entry/exit points (e.g., points 513, 515, and 517).

In one embodiment, while the UI 501 of FIGS. 5A through 5F are mainly discussed with respect to pick-up activities, it is contemplated that the UI 501 would operate similarly with respect to quickly and efficiently identifying an off-road drop-off location at the POI 503. For example, a user may be a driver or operator of a ride hailing vehicle 113 en route to drop off a passenger at an entrance of the POI 503 (e.g., entrance 513) or a user may be operating a ride sharing vehicle 113 (e.g., an automobile, a scooter, a bike, etc.) and she or he wants to quickly and efficiently return the vehicle 113 to the designated ride sharing drop-off location associated with the POI 503 (e.g., within a section of the parking lot 205).

Referring to FIG. 5A, in one embodiment, the UI 501 can provide a user (e.g., a driver or operator of a ride hailing vehicle 113) a warning or notification (e.g., “Warning! Approaching high volume pick-up area”) as the user is near or approaching the POI 503 (e.g., a large shopping center) that appears to have a relatively high volume of users at or near the POI 503 that are seeking ride hailing services (e.g., via the UI 501). In one embodiment, the UI 501 includes a “search for location” input 519 that allows the user to initiate the automatic identification of an off-road pickup location relative to the POI 503 as discussed with respect to the various embodiments described herein. In one instance, it is contemplated that the system 100 may automatically initiate the identification process based on one or more user settings, one or more parameters, etc. (e.g., proximity to the POI 503, number of nearby users seeking ride hailing services, etc.).

In one embodiment, the UI 501 also includes one or more inputs (e.g., inputs 521 and 523) that allow the user to modify or adjust the current or applicable segmentation parameters used by the system 100 in determining a candidate pickup/drop-off region, as depicted in FIG. 5B. In one instance, the UI 501 includes an “adjust time criteria” input 521 so that the user can adjust a difference criterion (for time) and an “adjust distance criteria” input 523 so that the user may adjust the disk criterion (for location). For example, in the instance where the system 100 determines a relatively high number of candidate pickup/drop-off locations at the POI 503 (e.g., areas 525, 527, 529, and 531), the user may want to increase the upper bound for the difference between the max timestamp and the min timestamp within a segment and the upper bound for the radius of a disk that can cover all points in a segment to possibly increase the accuracy of the identification or reduce the size of the candidate areas, which can reduce the time that the user must spend to find a passenger.

In contrast, in the instance where the system 100 determines a relatively low number of pickup regions or a relatively obscure pickup location (e.g., area 533) relative to the known entrances (e.g., 515 and 517), as depicted in FIG. 5C, the user may want to decrease the upper bound for the difference between the max timestamp and the min timestamp within a segment and the upper bound for the radius of a disk that can cover all points in a segment to possibly decrease the accuracy of the identification but generate more candidate regions or candidate regions with a greater bounded area. By way of example, this may be advantageous in terms of requiring minimal time and/or computational resources to automatically identify pickup/drop-off locations. In one embodiment, in the instance where the system 100 determines an obscure pickup location relative to the POI 503 (e.g., pickup location 533), the inputs 519 and 521 can allow a user (e.g., a software developer) to investigate and/or verify that the system 100 is in fact accurately identifying off-road pickup/drop-off locations at the POI 503 (e.g., based on a comparison with ground truth data).

Conversely, in one embodiment, the UI 501 can provide a user (e.g., a passenger) in need of a ride hailing vehicle 113 a warning or notification (e.g., “Warning! Multiple Available Vehicles Approaching”) while the user is located within the POI 503. In one embodiment, the UI 501 includes a “search for location” input 535 to allow the user to initiate the automatic identification of an off-road pickup location relative to the POI 503 as discussed with respect to the various embodiments described herein as well as a “select vehicle type” input 537 to allow the user to select among one or more vehicles 113 (e.g., autonomous, HAD vehicles, semi-autonomous vehicles, etc.). In one instance, the user may want to take a ride sharing vehicle 113 such as a scooter or bike depending on the length of her or his intended travel, one or more contextual parameters (e.g., time, weather, etc.), and/or the number of packages that the user may be holding. In this instance, the system 100 can output the pickup/drop-off locations of one or more ride sharing vehicles 113 to the user via the UI 501. As with the driver or operator use case, it is also contemplated that in the passenger use case, the system 100 may automatically initiate the identification process based on one or more user settings, one or more parameters, etc. For example, the system 100 may initiate the identification process once the user reaches a certain proximity (e.g., based on step count, GPS data, etc.) to the one or more entry/exit points of the POI 503 (e.g., 513, 515, and 517). In another example, the system 100 may automatically initiate the identification process based on one or more calendar entries in the user's UE 119 (e.g., a smartphone).

As described with respect to FIGS. 5B and 5C, in one embodiment, the UI 501 also includes one or more inputs (e.g., inputs 539 and 541) that can allow the user (e.g., a passenger or shopper) to modify or adjust the current or applicable segmentation parameters used by the system 100 in determining a candidate pickup region, as depicted in FIG. 5E. In one instance, the UI 501 includes an “adjust time criteria” input 539 so that the user may adjust a difference criterion (for time) and an “adjust distance criteria” input 541 so that the user may adjust the disk criterion (for location). For example, in the instance where the system 100 determines a relatively high number of candidate pickup locations (e.g., areas 543, 545, 547, and 549), the user may want to increase the upper bound for the difference between the max timestamp and the min timestamp within a segment and the upper bound for the radius of a disk that can cover all points in a segment to increase the accuracy of the identification or reduce the candidate areas relative to her or his location within the POI 503.

In contrast, in the instance where the system 100 determines a relatively low number of pickup regions or a relatively obscure pickup location (e.g., area 551) relative to the known entrances (e.g., 515 and 517), as depicted in FIG. 5F, the user may want to decrease the upper bound for the difference between the max timestamp and the min timestamp within a segment and the upper bound for the radius of a disk that can cover all points in a segment to possibly decrease the accuracy of the identification but generate more candidate regions or candidate regions with a greater bounded area to improve her or his chances of locating an available ride hailing or ride sharing vehicle 113.

In one embodiment, a user can interact with the inputs 519, 521, 523, 535, 537, 539, and 541 via one or more physical interactions (e.g., a touch, a tap, a gesture, typing, etc.), one or more voice commands (e.g., “identify pickup/drop-off locations,” “increase difference criteria threshold,” “decrease disk criteria threshold,” etc.), or a combination thereof.

Returning to FIG. 1, in one embodiment, the mapping platform 103 performs the process for automatically identifying off-road pickup/drop-off locations or other transportation transition regions based on probe trajectory data as discussed with respect to the various embodiments described herein. In one embodiment, the machine learning system 101 of the mapping platform 103 includes a neural network or other machine learning system to compare (e.g., iteratively) the threshold for difference criteria and the threshold for disk criteria against historic and/or current or real-time kinematics of pickup/drop-off activity (e.g., stored in or accessible via the probe data layer 123 and/or the geographic database 111) such that the time spent in a location of certain radius best describes (e.g., exceeds a threshold value) the kinematics of pickup/drop-off activity. In other words, the segmentation parameters that exceed the threshold value beast represent the kinematics of a pickup/drop-off activity, namely how long does a vehicle 113, a UE 119, or a combination thereof linger in certain region for pickup/drop-offs. In one embodiment, the inputs of the machine learning system 101 are (1) a candidate polygon; (2) a parking lot geometry inside the polygon; (3) segmentation parameters; and (4) clustering parameters and the output is the convex hull as a candidate off-road pickup/drop-off region. In one instance, the neural network of the machine learning system 101 is a traditional convolutional neural network which consists of multiple layers of collections of one or more neurons (which are configured to process a portion of an input data). In one embodiment, the machine learning system 101 also has connectivity or access over the communication network 117 to the probe data layer 123 and/or the geographic database 111 that can each store probe data, labeled or marked features (e.g., historical pickup/drop-off locations and/or real-time actual observed pickup/drop-off locations), etc.

In one embodiment, the mapping platform 103 has connectivity over the communications network 117 to the services platform 125 (e.g., an OEM platform) that provides the services 127a-127n (also collectively referred to herein as services 127) (e.g., probe and/or sensor data collection services, mapping/routing services, ride hailing or ride sharing services, etc.). By way of example, the services 127 may also be other third-party services and include mapping services, navigation services, ride hailing or ride sharing reservation or booking services (e.g., booking a ride hailing vehicle 113), guidance services, notification services, social networking services, content (e.g., audio, video, images, etc.) provisioning services, application services, storage services, contextual information determination services, location-based services, information-based services (e.g., weather, news, etc.), etc. In one embodiment, the services platform 125 uses the output (e.g. a candidate pickup/drop-off location) of the mapping platform 103 to provide services such as navigation, mapping, other location-based services, etc. In one instance, the services 127 provide representations of each user (e.g., a profile), his/her social links, and a variety of additional information (e.g., a user or ride hailing service rating). In one instance, the services 127 can allow users to share pickup/drop-off location information, activities information, POI related information, contextual information, and interests within their individual networks, and provide for data portability.

In one embodiment, the mapping platform 103 may be a platform with multiple interconnected components. The mapping platform 103 may include multiple servers, intelligent networking devices, computing devices, components and corresponding software for providing parametric representations of lane lines. In addition, it is noted that the mapping platform 103 may be a separate entity of the system 100, a part of the services platform 125, a part of the one or more services 127, or included within a vehicle 113 (e.g., an embedded navigation system).

In one embodiment, content providers 129a-129n (also collectively referred to herein as content providers 129) may provide content or data (e.g., including navigation-based content such as destination information, parking lot information, routing instructions, estimated time of arrival, POI related data such as entry-exit points, historical pickup/drop-off locations, ride hailing service booking or contact information, etc.) to the mapping platform 103, the geographic database 111, the vehicles 113, the UEs 119, the applications 121, the probe data layer 123, the services platform 125, and the services 127. The content provided may be any type of content, such as map content, contextual content, audio content, video content, image content (e.g., aerial images of a POI and/or associated parking areas), etc. In one embodiment, the content providers 129 may also store content associated with the mapping platform 103, the geographic database 111, the vehicles 113, the UEs 119, the applications 121, the probe data layer 123, the services platform 125, and/or the services 127. In another embodiment, the content providers 129 may manage access to a central repository of data, and offer a consistent, standard interface to data, such as a repository of the geographic database 111 and/or the probe data layer 123.

By way of example, the UEs 119 are any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that a UE 119 can support any type of interface to the user (such as “wearable” circuitry, etc.). In one embodiment, a UE 119 may be associated with a vehicle 113 (e.g., a mobile device) or be a component part of the vehicle 113 (e.g., an embedded navigation system). In one embodiment, the UEs 119 may include the mapping platform 103 to automatically identify off-road pickup/drop-off locations or other transportation transition regions based on probe trajectory data.

In one embodiment, as mentioned above, the vehicles 113, for instance, are part of a probe-based system or fleet for collecting probe data for detecting actual probe trajectories or traces on and off a road network. In one embodiment, each vehicle 113 is configured to report probe data as probe points, which are individual data records collected at a point in time that records telemetry data for that point in time. In one embodiment, the probe ID can be permanent or valid for a certain period of time. In one embodiment, the probe ID is cycled, particularly for consumer-sourced data, to protect the privacy of the source.

In one embodiment, a probe point can include attributes such as: (1) probe ID, (2) longitude, (3) latitude, (4) heading, (5) speed, and (6) time. The list of attributes is provided by way of illustration and not limitation. Accordingly, it is contemplated that any combination of these attributes or other attributes may be recorded as a probe point. For example, attributes such as altitude (e.g., for flight capable vehicles or for tracking non-flight vehicles in the altitude domain), tilt, steering angle, wiper activation, etc. can be included and reported for a probe point. In one instance, one or more attributes associated with or indicative of picking up or dropping off a passenger (e.g., braking, a door opening, hazard lights blinking, etc.) may also be included and reported for a probe point. In one embodiment, the vehicles 113 may include vehicle sensors 115 for reporting measuring and/or reporting attributes. The attributes can also be any attribute normally collected by an on-board diagnostic (OBD) system of the vehicle 113, and available through an interface to the OBD system (e.g., OBD II interface or other similar interface).

The probe points can be reported from the vehicles 113 in real-time, in batches, continuously, or at any other frequency requested by the system 100 over, for instance, the communication network 117 for processing by the mapping platform 103. In one embodiment, the probe points are map matched to specific road links stored in the geographic database 111 and/or probe data layer 123. In one embodiment, the system 100 (e.g., via the mapping platform 103) identifies vehicle paths or trajectories from the observed and expected frequency of probe points for an individual probe as discussed with respect to the various embodiments described herein so that the probe traces represent a user travel trajectory or a vehicle path of the probe through the road network as well as between an on-road regime, an off-road regime, and/or a parking lot.

In one embodiment, as previously stated, the vehicles 113 are configured with various sensors (e.g., vehicle sensors 115) for generating or collecting probe data, sensor data, related geographic/map data, etc. In one embodiment, the sensed data represents sensor data associated with a geographic location or coordinates at which the sensor data was collected (e.g., a latitude and longitude pair). In one embodiment, the probe data (e.g., stored in the probe data layer 123) includes location probes collected by one or more vehicle sensors 115. By way of example, the vehicle sensors 115 may include a RADAR system, a LiDAR system, global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data, an audio recorder for gathering audio data, velocity sensors mounted on a steering wheel of the vehicles 113, switch sensors for determining whether one or more vehicle switches are engaged (e.g., hazard lights), and the like.

Other examples of sensors 115 of a vehicle 113 may include light sensors, orientation sensors augmented with height sensors and acceleration sensor (e.g., an accelerometer can measure acceleration or braking and can be used to determine orientation of the vehicle), tilt sensors to detect the degree of incline or decline of a vehicle 113 along a path of travel, moisture sensors, pressure sensors, etc. In one embodiment, the sensors 115 may detect whether the vehicle 113 is deaccelerating or braking, whether one or more doors of the vehicle are open or ajar, and/or whether a passenger is sitting in or getting up from a seat within the vehicle 113 (e.g., in connection with a passenger or driver entering or existing the vehicle 113). In a further example embodiment, vehicle sensors 115 about the perimeter of a vehicle 113 may detect the relative distance of the vehicle 113 from a physical divider, a lane line of a link or roadway, the presence of other vehicles, pedestrians, traffic lights, potholes and any other objects, or a combination thereof. In one scenario, the vehicle sensors 115 may detect weather data, traffic information, or a combination thereof. In one embodiment, a vehicle 113 may include GPS or other satellite-based receivers 115 to obtain geographic coordinates from satellites 131 for determining current location and time. Further, the location can be determined by visual odometry, triangulation systems such as A-GPS, Cell of Origin, or other location extrapolation technologies.

In one embodiment, the UEs 119 may also be configured with various sensors (not shown for illustrative convenience) for acquiring and/or generating probe data and/or sensor data associated with a vehicle 113, a driver, a passenger, other vehicles, conditions regarding the driving environment or roadway, etc. For example, such sensors may be used as GPS receivers for interacting with the one or more satellites 131 to determine and track the current speed, position and location of a vehicle 113 or a user travelling on an on-road segment, an off-road segment, or a parking lot associated with a POI. In addition, the sensors may gather tilt data (e.g., a degree of incline or decline of the vehicle during travel), motion data, light data, sound data, image data, weather data, temporal data and other data associated with the vehicles 113 and/or UEs 119. Still further, the sensors may detect local or transient network and/or wireless signals, such as those transmitted by nearby devices during navigation of a vehicle 113 along a roadway (Li-Fi, near field communication (NFC)) etc.

It is noted therefore that the above described data may be transmitted via the communication network 117 as probe data (e.g., GPS probe data) according to any known wireless communication protocols. For example, each vehicle 113, user, UE 119, and/or application 121 may be assigned a unique probe identifier (probe ID) for use in reporting or transmitting said probe data collected by the vehicles 113 and/or UEs 119. In one embodiment, each vehicle 113 and/or UE 119 is configured to report probe data as probe points, which are individual data records collected at a point in time that records telemetry data.

In one embodiment, the mapping platform 103 retrieves aggregated probe points gathered and/or generated by the vehicle sensors 115 and/or the UEs 119 resulting from the travel of the UEs 119 and/or vehicles 113 on an on-road and/or off-road segment within a geographic area. In one instance, the probe data layer 123 stores a plurality of probe points and/or trajectories generated by different vehicles 113, vehicle sensors 115, UEs 119, applications 121, etc. over a period while traveling in a large monitored area (e.g., between an on-road location and an off-road parking lot associated with a POI). A time sequence of probe points specifies a trajectory—i.e., a path traversed by a vehicle 113, UE 119, application 121, etc. over the period.

In one embodiment, the communication network 117 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for 5G New Radio (5G NR or simply 5G), microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the mapping platform 103, vehicles 113, vehicle sensors 115, UEs 119, applications 121, services platform 125, services 127, content providers 129, and/or satellites 131 communicate with each other and other components of the system 100 using well known, new or still developing protocols. In this context, a protocol includes a set of rules defining how the network nodes within the communication network 117 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

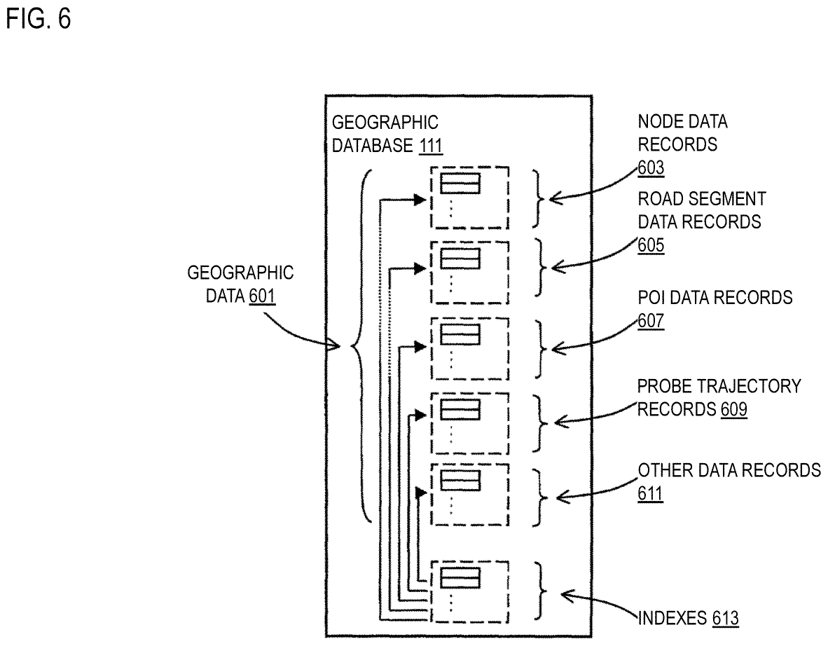

FIG. 6 is a diagram of the geographic database 111, according to one embodiment. In one embodiment, the geographic database 111 includes geographic data 601 used for (or configured to be compiled to be used for) mapping and/or navigation-related services, such as identifying off-road pickup/drop-off locations associated with a POI (e.g., within a hospital parking lot). In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 111.

“Node”—A point that terminates a link.

“Line segment”—A straight line connecting two points.

“Link” (or “edge”)—A contiguous, non-branching string of one or more-line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 111 follows certain conventions. For example, links do not cross themselves and do not cross each other except at a node. Also, there are no duplicated shape points, nodes, or links. Two links that connect each other have a common node. In the geographic database 111, overlapping geographic features are represented by overlapping polygons. When polygons overlap, the boundary of one polygon crosses the boundary of the other polygon. In the geographic database 111, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 111 includes node data records 603, road segment or link data records 605, Point of Interest (POI) data records 607, probe trajectory records 609, other records 611, and indexes 613, for example. More, fewer or different data records can be provided. In one embodiment, additional data records (not shown) can include cartographic (“carto”) data records, routing data, and maneuver data. In one embodiment, the indexes 613 may improve the speed of data retrieval operations in the geographic database 111. In one embodiment, the indexes 613 may be used to quickly locate data without having to search every row in the geographic database 111 every time it is accessed. For example, in one embodiment, the indexes 613 can be a spatial index of the polygon points associated with stored feature polygons.

In exemplary embodiments, the road segment data records 605 are links or segments representing roads, streets, or paths, as can be used in the calculated route or recorded route information for determination of one or more personalized routes, an estimated time of arrival, or a combination thereof (e.g., an estimated time of arrival of a ride hailing vehicle 113 at a POI pickup/drop-off point). The node data records 603 are end points corresponding to the respective links or segments of the road segment data records 605. The road link data records 605 and the node data records 603 represent a road network, such as used by vehicles, cars, and/or other entities. Alternatively, the geographic database 111 can contain path segment and node data records or other data that represent pedestrian paths, bicycles paths, or areas in addition to or instead of the vehicle road record data, for example.

The road/link segments and nodes can be associated with attributes, such as functional class, a road elevation, a speed category, a presence or absence of road features, geographic coordinates, street names, address ranges, speed limits, turn restrictions at intersections, and other navigation related attributes, as well as POIs, such as hospitals, shopping centers, airports, hotels, restaurants, museums, stadiums, offices, automobile dealerships, auto repair shops, buildings, parks, etc. The geographic database 111 can include data about the POIs (e.g., associated parking lot geometry and/or boundaries) and their respective locations in the POI data records 607. The geographic database 111 can also include data about places, such as cities, towns, or other communities, and other geographic features, such as bodies of water (e.g., lakes), mountain ranges, etc. In one instance, the POI data records 607 can include entry-exit point information (e.g., numbers and locations of entry-exit points), historic pickup/drop-off locations (e.g., bus stops, public transit access, etc.), historic pedestrian traffic flows at the POI, historical vehicular traffic flows proximate to and/or adjacent to the POI (e.g., in an associated parking lot), opening and closing times of the POI, etc. Such place or feature data can be part of the POI data records 607 or can be associated with POIs or POI data records 607 (such as a data point used for displaying or representing a position of a city).

In one embodiment, the geographic database 111 includes probe trajectory records 609 (e.g., probe trajectories that intersect a geographic area encompassing a POI with an associated off-road region) for current and historical probe data (e.g., vehicle 113 and/or UE 119 data), time window data, secondary probe trajectory records (e.g., a second path or trajectory generated by a UE 119 after a passenger exits a vehicle 113), probe trajectory related features (e.g., or more contextual parameters), enhanced probe trajectory features, probe trajectory probabilities/weights (e.g., used in training the machine learning system 101), sensor data, and/or any other related data. In one embodiment, the probe trajectory records may include one or more transition segments (e.g., (a)<on-road> to <off-road>; (b)<off-road> to <parking lot>; or (c)<parking lot> to <off-road>) and/or one or more transportation transition regions (e.g., any geographic area or location where a user or passenger transitions from one mode of transportation to another or she or he transitions from one transportation service to another) for future use and/or reference (e.g., by the machine learning system 101). The probe trajectory records 609 include the probe data layer 123 that stores the vehicle 113 and/or user paths and volume feature values generated according to the various embodiments described herein. The probe data layer 123 can be provided to other system 100 components or end users to provide related mapping, navigation, and/or other location-based services (e.g., ride hailing or ride sharing services). In one embodiment, the probe trajectory records 609 can be associated with one or more of the node data records 603, road segment or link records 605, and/or POI data records 607; or portions thereof (e.g., smaller or different segments than indicated in the road segment records 605) to support localization and opportunistic use of ride hailing or ride sharing services in connection with transit to and from a POI (e.g., a hospital, shopping center, airport, etc.).

In one embodiment, the geographic database 111 can be maintained by the services platform 125 (e.g., a map developer). The map developer can collect geographic data to generate and enhance the geographic database 111. There can be different ways used by the map developer to collect data. These ways can include obtaining data from other sources, such as municipalities or respective geographic authorities. In addition, the map developer can employ field personnel to observe features (e.g., ground truth pickup/drop-off locations associated with a POI) and/or record information about them, for example. Also, remote sensing, such as aerial or satellite photography, can be used.

In one embodiment, the geographic database 111 includes high resolution or high definition (HD) mapping data that provide centimeter-level or better accuracy of map features. For example, the geographic database 111 can be based on Light Detection and Ranging (LiDAR) or equivalent technology to collect billions of 3D points and model road surfaces and other map features (e.g., parking lot geometry) down to the number lanes and their widths. In one embodiment, the HD mapping data capture and store details such as the slope and curvature of the road, lane markings, roadside objects such as sign posts, including what the signage denotes. By way of example, the HD mapping data enable highly automated vehicles to precisely localize themselves on a road or within a parking lot, and to determine on-road or off-road attributes (e.g., learned speed limit values) at high accuracy levels.

In one embodiment, the geographic database 111 is stored as a hierarchical or multi-level tile-based projection or structure. More specifically, in one embodiment, the geographic database 111 may be defined according to a normalized Mercator projection. Other projections may be used. By way of example, the map tile grid of a Mercator or similar projection is a multilevel grid. Each cell or tile in a level of the map tile grid is divisible into the same number of tiles of that same level of grid. In other words, the initial level of the map tile grid (e.g., a level at the lowest zoom level) is divisible into four cells or rectangles. Each of those cells are in turn divisible into four cells, and so on until the highest zoom or resolution level of the projection is reached.

In one embodiment, the map tile grid may be numbered in a systematic fashion to define a tile identifier (tile ID). For example, the top left tile may be numbered 00, the top right tile may be numbered 01, the bottom left tile may be numbered 10, and the bottom right tile may be numbered 11. In one embodiment, each cell is divided into four rectangles and numbered by concatenating the parent tile ID and the new tile position. A variety of numbering schemes also is possible. Any number of levels with increasingly smaller geographic areas may represent the map tile grid. Any level (n) of the map tile grid has 2(n+1) cells. Accordingly, any tile of the level (n) has a geographic area of A/2(n+1) where A is the total geographic area of the world or the total area of the map tile grid 10. Because of the numbering system, the exact position of any tile in any level of the map tile grid or projection may be uniquely determined from the tile ID.

In one embodiment, the system 100 may identify a tile by a quadkey determined based on the tile ID of a tile of the map tile grid. The quadkey, for example, is a one-dimensional array including numerical values. In one embodiment, the quadkey may be calculated or determined by interleaving the bits of the row and column coordinates of a tile in the grid at a specific level. The interleaved bits may be converted to a predetermined base number (e.g., base 10, base 4, hexadecimal). In one example, leading zeroes are inserted or retained regardless of the level of the map tile grid in order to maintain a constant length for the one-dimensional array of the quadkey. In another example, the length of the one-dimensional array of the quadkey may indicate the corresponding level within the map tile grid 10. In one embodiment, the quadkey is an example of the hash or encoding scheme of the respective geographical coordinates of a geographical data point that can be used to identify a tile in which the geographical data point is located.

The geographic database 111 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 113, a vehicle sensor 115 and/or a UE 119. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for automatically identifying off-road pickup/drop-off locations or other transportation transition regions based on probe trajectory data may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

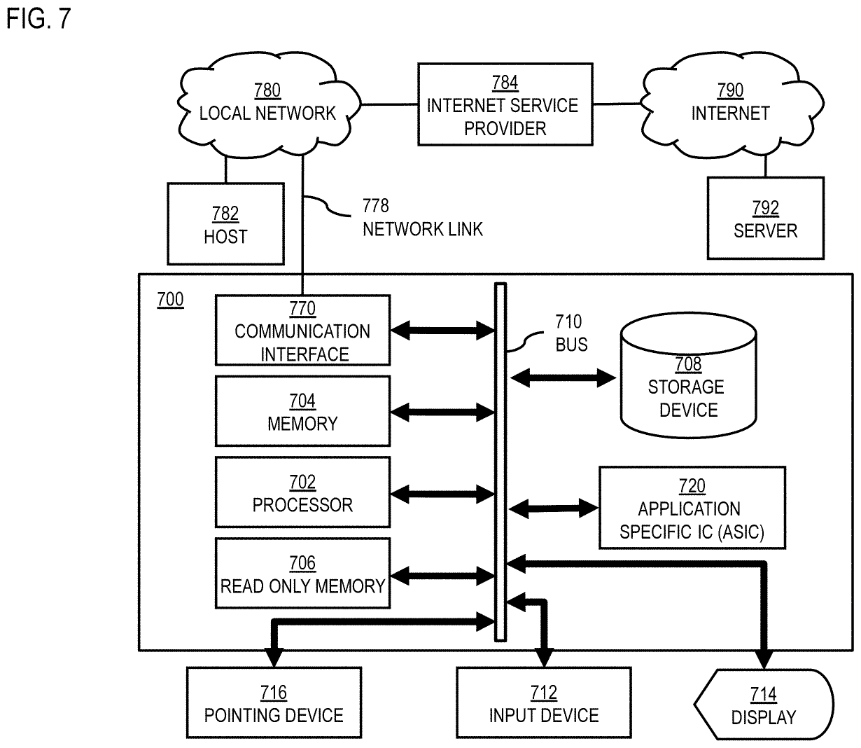

FIG. 7 illustrates a computer system 700 upon which an embodiment of the invention may be implemented. Computer system 700 is programmed (e.g., via computer program code or instructions) to automatically identify off-road pickup/drop-off locations or other transportation transition regions based on probe trajectory data as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to automatically identifying off-road pickup/drop-off locations or other transportation transition regions based on probe trajectory data. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for automatically identifying off-road pickup/drop-off locations or other transportation transition regions based on probe trajectory data. Dynamic memory allows information stored therein to be changed by the computer system 700. RANI allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for automatically identifying off-road pickup/drop-off locations or other transportation transition regions based on probe trajectory data, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general, the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 117 for automatically identifying off-road pickup/drop-off locations or other transportation transition regions based on probe trajectory data.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

FIG. 8 illustrates a chip set 800 upon which an embodiment of the invention may be implemented. Chip set 800 is programmed to automatically identify off-road pickup/drop-off locations or other transportation transition regions based on probe trajectory data as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to automatically identify off-road pickup/drop-off locations or other transportation transition regions based on probe trajectory data. The memory 805 also stores the data associated with or generated by the execution of the inventive steps.

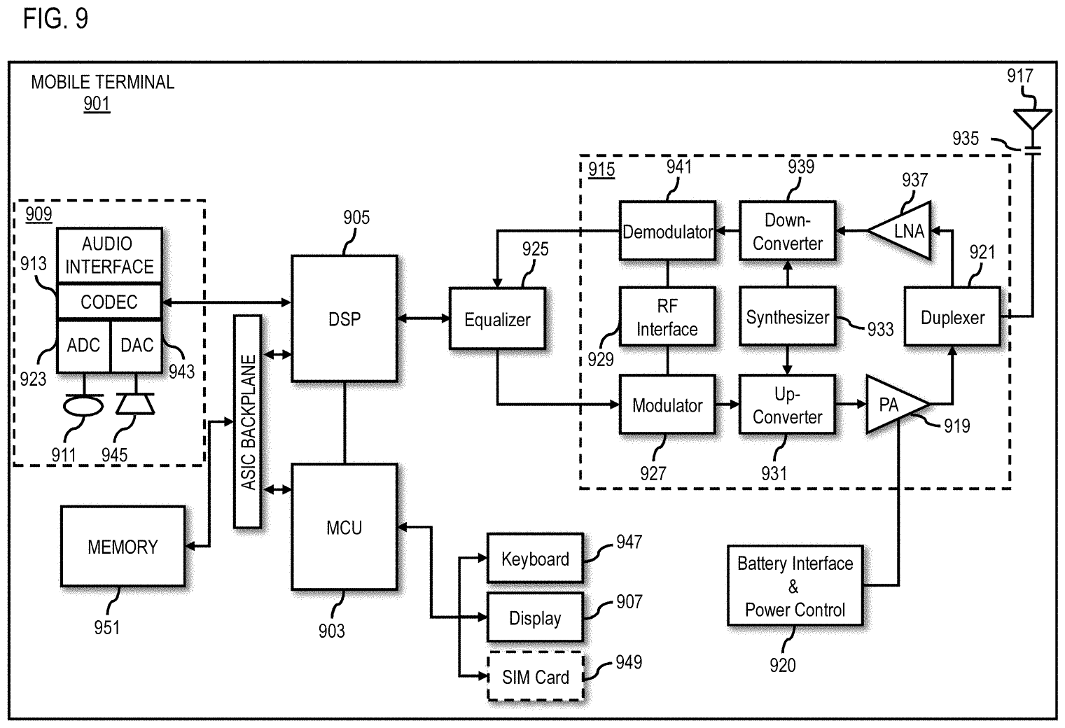

FIG. 9 is a diagram of exemplary components of a mobile terminal 901 (e.g., a vehicle 113, a UE 119, or a component thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions that offer automatic contact matching. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile station 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., 5G New Radio (5G NR or simply 5G), microwave access (WiMAX), Long Term Evolution (LTE) networks, code division multiple access (CDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a landline connected to a Public Switched Telephone Network (PSTN), or other telephony networks.

Voice signals transmitted to the mobile station 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile station 901 to automatically identify off-road pickup/drop-off locations or other transportation transition regions based on probe trajectory data. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile station 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 951 may be, but not limited to, a single memory, CD, DVD, ROM, RAM, EEPROM, optical storage, or any other non-volatile or non-transitory storage medium capable of storing digital data.

An optionally incorporated SIM card 949 carries, for instance, important information, such as the cellular phone number, the carrier supplying service, subscription details, and security information. The SIM card 949 serves primarily to identify the mobile station 901 on a radio network. The card 949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method for identifying a transportation transition region from probe trajectory data comprising:
determining a geographic area, wherein the geographic area encompasses a point of interest and an off-road region associated with the point of interest;
retrieving one or more probe trajectories that intersect the geographic area;
segmenting the one or more probe trajectories into a plurality of segments, wherein the plurality of segments includes one or more on-road segments, one or more off-road segments, or a combination thereof;
processing the plurality of segments to identify one or more transition segments that include a transition involving an on-road segment of the one or more on-road segments or an off-road segment of the one or more off-road segments;
clustering one or more probe points of the one or more transition segments to identify the transportation transition region; and
providing the transportation transition region as an update to a geographic database, a mapping database, a navigation database, or a combination thereof.

2. The method of claim 1, wherein the transportation transition region includes a pick-up location, a drop-off location, or a combination thereof for a vehicle to pick-up or drop-off a passenger.

3. The method of claim 1, wherein the segmenting of the one or more probe trajectories is performed using a monotone segmentation based on one or more segmentation criteria.

4. The method of claim 3, wherein the one or more segmentation criteria include a temporal criterion, a location criterion, or a combination thereof.

5. The method of claim 4, wherein the temporal criterion is based on a difference between a maximum timestamp and a minimum time stamp within a segment, and wherein the location criterion is based on a radius of a disk that can cover the one or more probe points of the segment.

6. The method of claim 3, further comprising:
determining one or more thresholds for the one or more segmentation criteria based on kinematics of a transportation transition activity that is associated with the transportation transition region.

7. The method of claim 6, wherein the transportation transition activity includes picking-up/dropping off a passenger of a vehicle, transitioning between a first mode of transportation to a second mode of transportation, or a combination thereof.

8. The method of claim 1, further comprising:
combining the plurality of segments using a start/stop matrix.

9. The method of claim 1, further comprising:
generating a convex hull of the clustered one or more probe points,
wherein the transportation transition region is identified based on a portion of the geographic area delineated by the convex hull.

10. The method of claim 1, further comprising:
map-matching the plurality of segments to digital map data to determine the one or more on-road segments, the one or more off-road segments, or a combination thereof.

11. The method of claim 1, further comprising:
map-matching the plurality of segments to a geographic feature represented in digital map data,
wherein the one or more transitions segments are further identified based on the map-matching.

12. The method of claim 11, wherein the geographic feature is a parking area.

13. An apparatus for identifying a transportation transition region from probe trajectory data comprising:
at least one processor; and
at least one memory including computer program code for one or more programs,
the at least one memory and the computer program code configured to, with the at least one processor, cause the apparatus to perform at least the following,
determine a geographic area, wherein the geographic area encompasses a point of interest and an off-road region associated with the point of interest;
retrieve one or more probe trajectories that intersect the geographic area;
segment the one or more probe trajectories into a plurality of segments, wherein the plurality of segments includes one or more on-road segments, one or more off-road segments, or a combination thereof;
process the plurality of segments to identify one or more transition segment that includes a transition involving an on-road segment of the one or more on-road segments or an off-road segment of the one or more off-road segments;
cluster one or more probe points of the one or more transition segments to identify the transportation transition region; and
provide the transportation transition region as an update to a geographic database, a mapping database, a navigation database, or a combination thereof.

14. The apparatus of claim 13, wherein the transportation transition region includes a pick-up location, a drop-off location, or a combination thereof for a vehicle to pick-up or drop-off a passenger.

15. The apparatus of claim 13, wherein the segmenting of the one or more probe trajectories is performed using a monotone segmentation based on one or more segmentation criteria.

16. The apparatus of claim 15, wherein the one or more segmentation criteria include a temporal criterion, a location criterion, or a combination thereof.

17. The apparatus of claim 15, wherein the apparatus is further caused to:
determine one or more thresholds for the one or more segmentation criteria based on kinematics of a transportation transition activity that is associated with the transportation transition region.

18. The apparatus of claim 17, wherein the transportation transition activity includes picking-up/dropping off a passenger of a vehicle, transitioning between a first mode of transportation to a second mode of transportation, or a combination thereof.

19. A non-transitory computer-readable storage medium for identifying a transportation transition region from probe trajectory data, carrying one or more sequences of one or more instructions which, when executed by one or more processors, cause an apparatus to at least perform the following steps:
determining a geographic area, wherein the geographic area encompasses a point of interest and an off-road region associated with the point of interest;
retrieving one or more probe trajectories that intersect the geographic area;
segmenting the one or more probe trajectories into a plurality of segments based on kinematics of a transportation transition activity, wherein the plurality of segments includes one or more on-road segments, one or more off-road segments, or a combination thereof;
processing the plurality of segments to identify one or more transition segments that include a transition involving an on-road segment of the one or more on-road segments or an off-road segment of the one or more off-road segments;
clustering one or more probe points of the one or more transition segments to identify the transportation transition region; and
providing the transportation transition region as an output.

20. The non-transitory computer-readable storage medium of claim 19, wherein the transportation transition activity includes a picking-up/dropping off a passenger of a vehicle, transitioning between a first most of transportation to a second mode transportation, or a combination thereof.
